(19) United States
(12) Patent Application Publication
(10) Pub. No.: US 2023/0381987 A1
(43) Pub. Date: Nov. 30, 2023

(54) DEPILATORY DEVICE

(71) Applicant: Panasonic Intellectual Property Management Co., Ltd., Osaka (JP)

(72) Inventors: Yuya NAGASHIMA, Shiga (JP); Kenichi MURAKI, Shiga (JP); Daisuke SONE, Shiga (JP); Kotaro YANAGI, Shiga (JP)

(21) Appl. No.: 18/322,324

(22) Filed: May 23, 2023

(30) Foreign Application Priority Data
May 30, 2022 (JP) 2022-087515

(51) Int. Cl. B26B 19/06; B26B 19/38

(52) U.S. Cl. CPC B26B 19/063; B26B 19/386; B26B 19/382

(57) ABSTRACT

The present disclosure provides a depilatory device capable of further improving opening and closing operability of a lid part while moving a head part relative to a body. The depilatory device according to the present disclosure includes a body, and head part that includes a blade part which is configured to cut hair and supported by the body in a state where the head part is reciprocatable relative to the body in a first direction. Head part includes head housing provided inside with a space, and head housing comprises an opening window communicating with the space. Additionally, a lid part that is openable and configured to cover the opening window is attached to head housing. The lid part has an opening and closing direction intersecting trajectory drawn by the lid part when head part is reciprocated relative to the body in the first direction.

### BACKGROUND

### 1. Technical Field

The present disclosure relates to a depilatory device.

### 2. Description of the Related Art

As disclosed in PTL 1, an electric razor (i.e., an example of a depilatory device) including a body and a head part supported by the body is conventionally known.

PTL 1 discloses the head part including a blade part, and the head part is provided inside with a space capable of accumulating hairs. Then, the head part including the blade part is supported by the body while being capable of swinging in a width direction of the body. This configuration further enhances adhesion of the blade part to skin during use of the electric razor (i.e., an example of a depilatory device).

The electric razor (i.e., an example of a depilatory device) disclosed in PTL 1 also includes an opening window communicating with the space, the opening window being formed in the head part, and a lid part that is openable and configured to cover the opening window is attached to the head part. This configuration enables liquid such as water to be introduced into the space through the opening window, and hair or liquid accumulated in the space to be discharged through the opening window.

### CITATIONS LIST

### Patent Literature

PTL 1: Unexamined Japanese Patent Publication No. 2013-085870

### SUMMARY

As described above, the depilatory device, in which the head part is moved relative to the body to enhance adhesion of the blade part to skin, is preferably improved more in opening and closing operability of the lid part.

Thus, it is an object of the present disclosure to provide a depilatory device capable of further improving opening and closing operability of a lid part while moving a head part relative to a body.

A depilatory device according to an aspect of the present disclosure includes a body, and a head part including a blade part which is configured to cut hair and supported by the body in a state where the head part is reciprocatable relative to the body in a first direction. The head part includes a head housing provided inside with a space, and the head housing comprises an opening window communicating with the space. The opening window is covered with a lid part that is openable and attached to the head housing. The lid part has an opening and closing direction intersecting a trajectory drawn by the lid part when the head part is reciprocated relative to the body in the first direction.

The present disclosure enables obtaining the depilatory device capable of further improving the opening and closing operability of the lid part while moving the head part relative to the body.

### BRIEF DESCRIPTION OF THE DRAWINGS

FIG. 1 is a perspective view illustrating an electric razor as an example of a depilatory device;

FIG. 2 is a front view illustrating the electric razor;

FIG. 3 is a side view illustrating the electric razor;

FIG. 4 is an exploded perspective view of the electric razor;

FIG. 5 is a perspective view illustrating a coupling mechanism of the electric razor as viewed from one direction;

FIG. 6 is an exploded perspective view illustrating the coupling mechanism of the electric razor as viewed from one direction;

FIG. 7 is a perspective view illustrating the coupling mechanism of the electric razor as viewed from another direction;

FIG. 8 is an exploded perspective view illustrating the coupling mechanism of the electric razor as viewed from another direction;

FIG. 9 is a partially exploded perspective view of a head part of the electric razor;

FIG. 10 is an exploded perspective view illustrating a head cover part of the head part;

FIG. 11 is an exploded perspective view illustrating a head base part of the head part;

FIG. 12 is an exploded front view of the head part;

FIG. 13 is an exploded side view of the head part;

FIG. 14 is a partially cutaway perspective view of the electric razor;

FIG. 15 is a perspective view for illustrating a method for coupling the head part to a link mechanism;

FIG. 16 is a side view for illustrating a method for coupling the head part to the link mechanism;

FIG. 17 is a cross-sectional view illustrating the coupling state between the head part and the link mechanism;

FIG. 18 is a cross-sectional view illustrating swing of the head part in a front-rear direction, the cross-sectional view illustrating a state in which the head part is located on a foremost side;

FIG. 19 is a cross-sectional view illustrating swing of the head part in a front-rear direction, the cross-sectional view illustrating a state in which the head part is located at a central part;

FIG. 20 is a cross-sectional view illustrating swing of the head part in a front-rear direction, the cross-sectional view illustrating a state in which the head part is located on a rearmost side;

FIG. 21 is a cross-sectional view illustrating a modification of a method for supporting the head part being capable of swinging;

FIG. 22 is a front view illustrating an example of a method for forming an opening window in a head housing, the front view illustrating an outer housing and a cover housing that are disassembled;

FIG. 23 is a front view illustrating an example of a method for forming the opening window in the head housing, the front view illustrating the opening window defined by the outer housing and the cover housing;

FIG. 24 is a perspective view illustrating the head part when a lid part is closed;

FIG. 25 is a perspective view illustrating the head part when the lid part is opened;

FIG. 26 is a front view illustrating a relationship between swing of a head part in a left-right direction and opening and closing operation of the lid part, the front view illustrating the head part according to a comparative example;

FIG. 27 is a front view illustrating a relationship between swing of the head part in a left-right direction and opening and closing operation of the lid part, the front view illustrating the head part according to an exemplary embodiment;

FIG. 28 is a perspective view illustrating the lid part;

FIG. 29 is a front view illustrating the lid part;

FIG. 30 is a side view illustrating the lid part;

FIG. 31 is a cross-sectional view illustrating the lid part;

FIG. 32 is a cross-sectional view illustrating the head part when the lid part is closed;

FIG. 33 is a cross-sectional view illustrating the head part when the lid part is opened;

FIG. 34 is a diagram illustrating a positional relationship between a hook part and a locking part when the lid part is closed;

FIG. 35 is a diagram illustrating a positional relationship between the hook part and the locking part when the lid part is opened;

FIG. 36 is a diagram illustrating a state in which a locking claw of the hook part is locked to the locking part when the lid part is closed;

FIG. 37 is a diagram illustrating a state in which the locking claw of the hook part is locked to the locking part when the lid part is opened using the hook part and the locking part according to a modification;

FIG. 38 is a perspective view illustrating the head part when the lid part according to a modification is closed;

FIG. 39 is a perspective view illustrating the head part when the lid part according to a modification is opened;

FIG. 40 is a diagram illustrating a positional relationship between the hook part and the locking part when the lid part according to the modification is closed; and

FIG. 41 is a diagram illustrating a positional relationship between the hook part and the locking part when the lid part according to the modification is opened.

### DETAILED DESCRIPTIONS

Hereinafter, an exemplary embodiment will be described in detail with reference to the drawings. However, unnecessarily detailed description may not be described. For example, a detailed description of already well-known matters or a duplicated description of substantially the same configuration may not be described.

The accompanying drawings and the following description are merely presented to help those skilled in the art fully understand the present disclosure, and are not intended to limit the subject matters described in the scope of claims.

Exemplary embodiments below and modifications of the exemplary embodiments each exemplify an electric razor that cuts a beard (i.e., an example of body hair) of a user or the like as a depilatory device.

The exemplary embodiments below and their modifications are described with an X-direction (i.e., a first direction, a front-back direction, or a shaving direction) in which multiple blade blocks are disposed side by side, and a Y-direction (i.e., a second direction, a left-right direction, or a width direction) in which each of the blade blocks extends.

An up-down direction in a state where the head part (i.e., one element included in the electric razor) is disposed with a skin contact surface facing upward is described as a Z-direction (i.e., an up-down direction of the head part). The present exemplary embodiment includes a blade unit with the skin contact surface that is formed of surfaces (i.e., outer surfaces) of outer blades of the multiple blade blocks, and that can be approximated by a curved surface protruding outward as a whole. Thus, the exemplary embodiments below and their modifications are described with a state in which the head part (i.e., one element included in the electric razor) is disposed with the skin contact surface facing upward, that is, in which a point protruding outermost from the curved surface approximate to the skin contact surface of the blade unit is located at an uppermost part and a contact plane at the point protruding outermost from the curved surface approximate to the skin contact surface of the blade unit is a horizontal plane.

The exemplary embodiments below and their modifications are described with a side facing a user in a state where the user grips a grip of an electric shaver during normal use, the side being defined as a front side (i.e., a front side in the X-direction) of electric razor 1.

### EXEMPLARY EMBODIMENTS

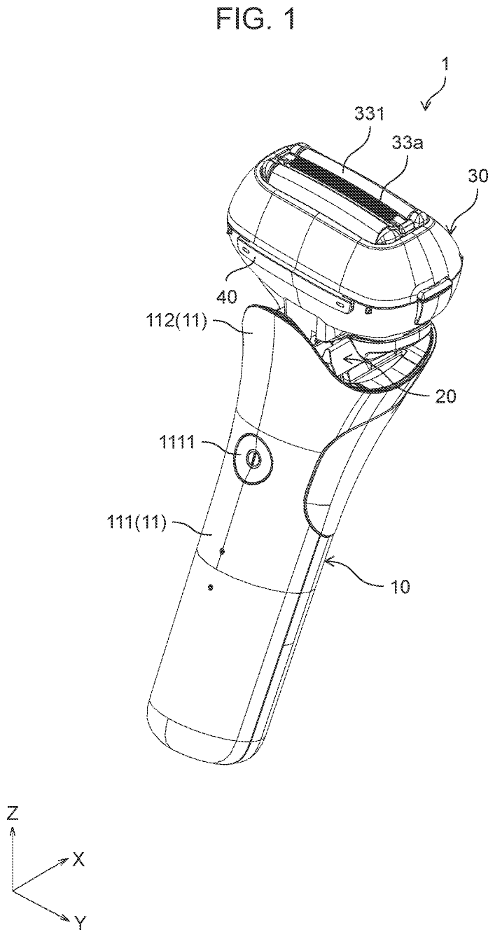

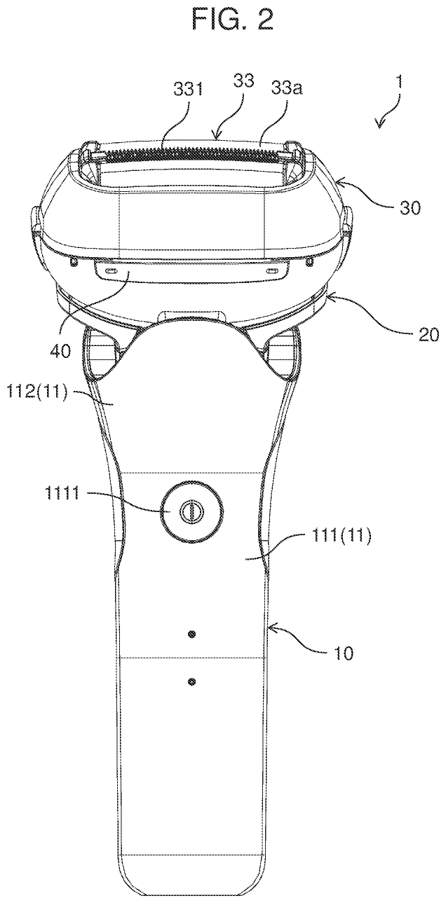

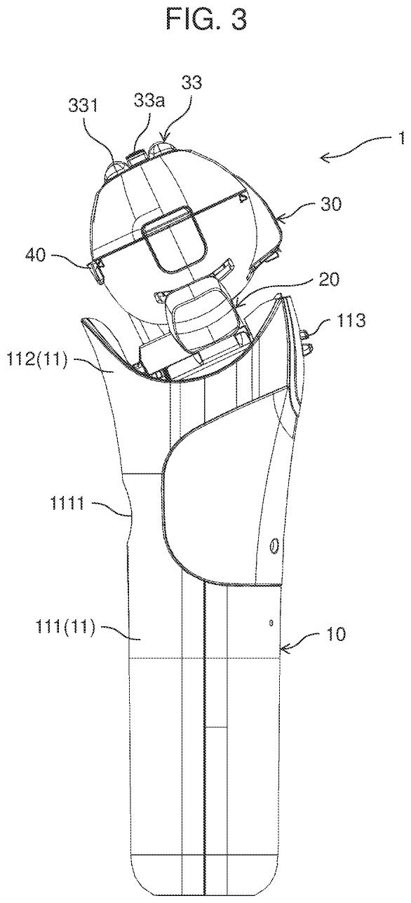

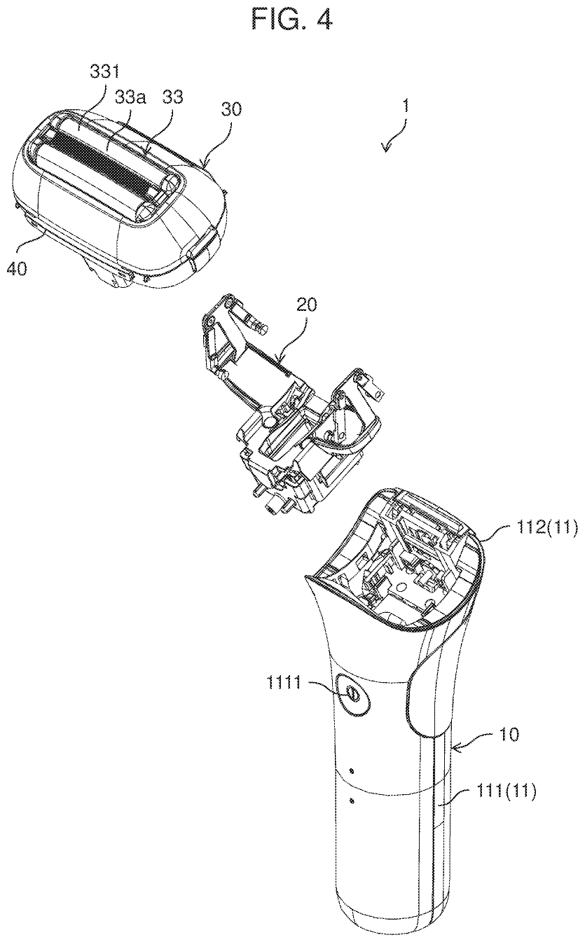

First, an outline of a configuration of electric razor 1 will be described with reference to FIGS. 1 to 4. FIG. 1 is a perspective view illustrating electric razor 1 as an example of a depilatory device. FIG. 2 is a front view illustrating electric razor 1. FIG. 3 is a side view illustrating electric razor 1. FIG. 4 is an exploded perspective view of electric razor 1.

As illustrated in FIGS. 1 to 4, electric razor 1 (i.e., an example of a depilatory device) according to the present exemplary embodiment includes: razor body 10 (i.e., a body); head part 30 that has blade part 331 capable of cutting beard (i.e., an example of hair) and is supported by razor body 10; and coupling mechanism 20 that couples head part 30 to razor body 10.

Razor body 10 includes body housing 11 that has a lower part in a tubular shape elongated vertically, the lower part having a substantially equal diameter. Body housing 11 has an upper part in a tubular shape having a diameter increasing upward. The lower part in a tubular shape having a substantially equal diameter of body housing 11 serves as grip 111 that can be held by a user or the like with his or her hand during use of electric razor 1. The upper part in a tubular shape having a diameter increasing upward of body housing 11 serves as coupling mechanism fixture 112 capable of fixing coupling mechanism 20 in a state where at least a lower part of coupling mechanism 20 is accommodated.

Body housing 11 can be formed by joining multiple divided bodies using screws or the like, and a cavity is formed inside body housing 11. Various electric components such as a rechargeable battery are accommodated in the cavity formed inside body housing 11. For example, the multiple divided bodies can be formed using a material such as synthetic resin or metal.

Grip 111 of body housing 11 is provided with power switch 1111 of a press type for operating electric razor 1. Power switch 1111 turns on and off a power supply of electric razor 1. Although the switch of a press type is exemplified as power switch 1111 according to the present exemplary embodiment, another switch such as a switch of a slide type may be used, as long as the switch can turn on and off the power supply.

Power switch 1111 according to the present exemplary embodiment is formed on a front surface of body housing 11 (more specifically, on grip 111), that is, on a front surface (i.e., on a front) of electric razor 1. This configuration allows a user or the like to operate power switch 1111 with a thumb of the user or the like while holding grip 111 of electric razor 1.

Head part 30 is supported by razor body 10 by causing coupling mechanism 20 to support head part 30 while coupling mechanism 20 is fixed to coupling mechanism fixture 112 of body housing 11. In the present exemplary embodiment, head part 30 is supported by razor body 10 while being inclined upward and forward in a state where an extending direction of razor body 10 substantially aligns with the up-down direction. This configuration allows the extending direction of razor body 10 to align with the up-down direction while a part of blade part 331 to be in contact with the skin (i.e., skin contact surface 33a, which will be described later) is inclined forward and downward with respect to the horizontal plane, and thus allowing skin contact surface 33a to be likely to come into contact with the skin of the user when the user grips grip 111 to use electric razor 1. Head part 30 may be configured not to be inclined with respect to razor body 10.

Here, head part 30 is supported by razor body 10 (more specifically, coupling mechanism 20) in a state of being allowed to be moved (e.g., reciprocating linear motion, swinging, and the like) relative to razor body 10 in at least one direction.

In the present exemplary embodiment, head part 30 is configured to be allowed to swing in the Y-direction with respect to razor body 10. Head part 30 is also configured to be allowed to swing in the X-direction with respect to razor body 10. Head part 30 is also configured to be allowed to float in the Z-direction relative to razor body 10. This configuration enables further enhancing adhesion of blade part 331 to the skin during use of electric razor 1, and thus enabling efficient shaving of beard (i.e., an example of hair). The term, “shaving”, in the present description is an example of hair removal.

Head part 30 may be configured to be moved relative to razor body 10 in one direction or two directions. For example, head part 30 may be configured to be moved relative to razor body 10 only in one of the X-direction, the Y-direction, and the Z-direction. Head part 30 may be configured to be moved relative to razor body 10 in any two of the X-direction, the Y-direction, and the Z-direction.

In the present exemplary embodiment, coupling mechanism 20 includes a first swinging mechanism that swings head part 30 in the X-direction, a second swinging mechanism that swings head part 30 in the Y-direction, and a float mechanism that floats head part 30 in the Z-direction.

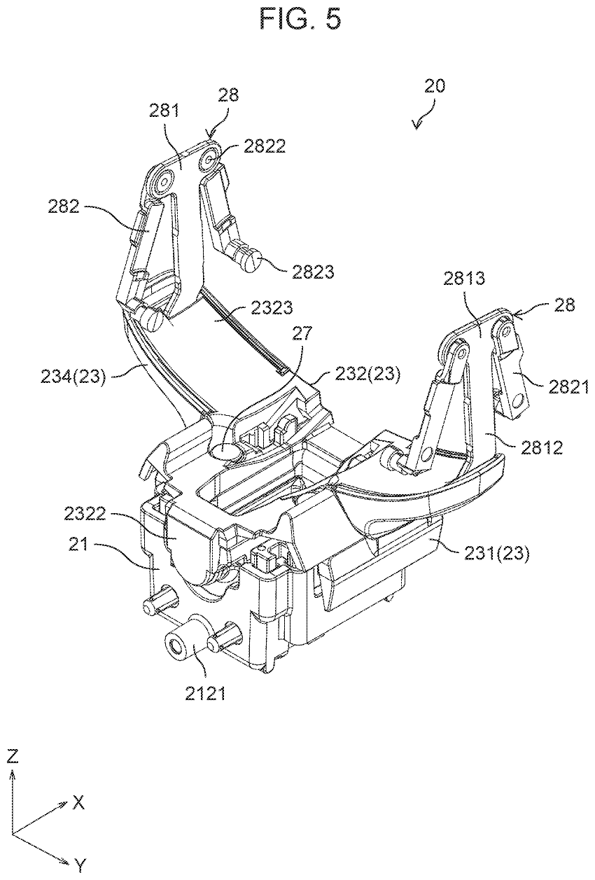

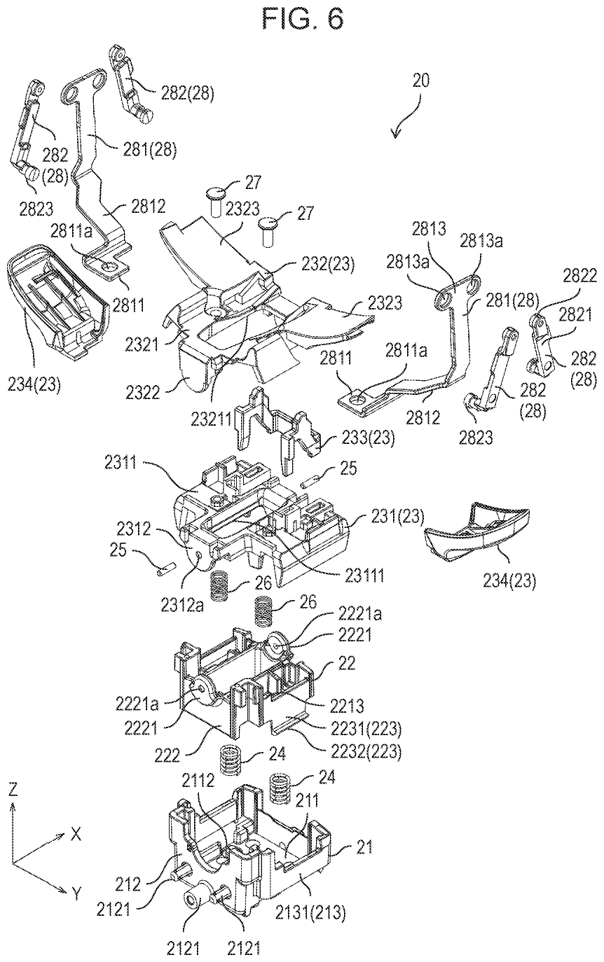

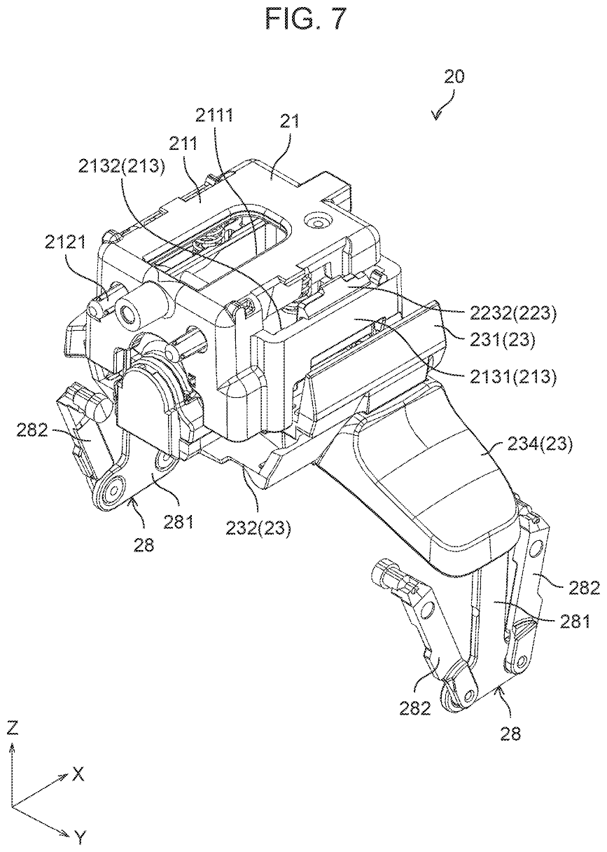

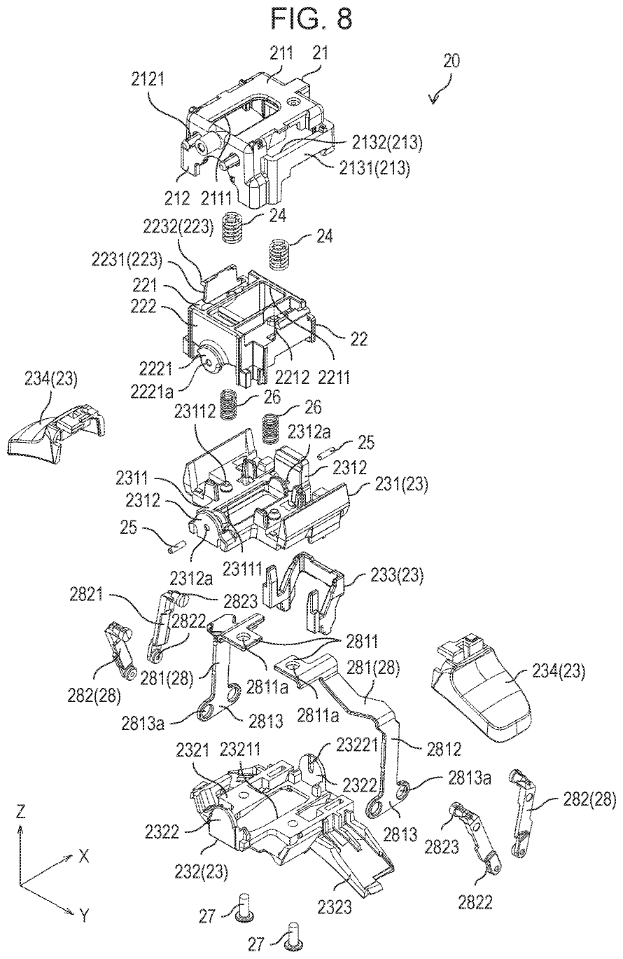

Next, a specific configuration of coupling mechanism 20 will be described with reference to FIGS. 5 to 8. FIG. 5 is a perspective view illustrating coupling mechanism 20 of electric razor 1 as viewed from one direction. FIG. 6 is an exploded perspective view illustrating coupling mechanism 20 of electric razor 1 as viewed from one direction. FIG. 7 is a perspective view illustrating coupling mechanism 20 of electric razor 1 as viewed from another direction. FIG. 8 is an exploded perspective view illustrating coupling mechanism 20 of electric razor 1 as viewed from another direction.

As illustrated in FIGS. 5 to 8, coupling mechanism 20 is formed by assembling multiple divided bodies, and includes first coupler 21 fixed to coupling mechanism fixture 112 of razor body 10, second coupler 22 attached to first coupler 21, and third coupler 23 attached to second coupler 22.

As illustrated in FIG. 6, first coupler 21 has a substantially rectangular box shape opening upward, and includes bottom wall 211 having a substantially rectangular plate shape, and peripheral wall 212 that is connected to a peripheral end of bottom wall 211 while extending upward. As illustrated in FIG. 8, bottom wall 211 is provided at its central part with through-hole 2111 passing through the central part in the Z-direction (i.e., the up-down direction), so that a lead wire or the like for supplying electric power to drive mechanism 315 described later and incorporated in head part 30 can be inserted through bottom wall 211.

Then, peripheral wall 212 is provided on its outer peripheral part with engagement rib 2121 protruding outward. Engaging engagement rib 2121 with coupling mechanism fixture 112 or fixing engagement rib 2121 to coupling mechanism fixture 112 using a screw or the like causes first coupler 21 to be fixed to coupling mechanism fixture 112 of razor body 10. At this time, first coupler is fixed to coupling mechanism fixture 112 in a state where first coupler 21 cannot be moved relative to razor body 10.

Second coupler 22 also has a substantially rectangular box shape opening upward, and includes bottom wall 221 having a substantially rectangular plate shape, and peripheral wall 222 that is connected to a peripheral end of bottom wall 221 while extending upward. As illustrated in FIG. 8, bottom wall 221 is provided at its central part with through-hole 2211 passing through the central part in the Z-direction (i.e., the up-down direction), so that a lead wire or the like can be inserted through bottom wall 221.

Inserting second coupler 22 into first coupler 21 from above causes second coupler 22 to be attached to first coupler 21. At this time, second coupler 22 is attached to first coupler 21 with coil spring 24 interposed between second coupler 22 and first coupler 21. Thus, second coupler 22 can be floated from first coupler 21 in the Z-direction.

In the present exemplary embodiment, spring receiving projections 2112 protruding upward are provided on respective sides in the Y-direction of an upper surface of bottom wall 211 of first coupler 21 as illustrated in FIG. 6. Spring receiving projections 2212 protruding downward are provided on respective sides in the Y-direction of a lower surface of bottom wall 221 of second coupler 22 as illustrated in FIG. 8. Upper and lower ends of a pair of coil springs 24 are inserted into corresponding spring receiving projections 2112 and 2212. This configuration allows second coupler 22 to be attached to first coupler 21 while being floatable from first coupler 21 in the Z-direction.

Second coupler 22 is provided with locking part 223 for locking second coupler 22 to first coupler 21, and first coupler 21 is provided with locked part 213 to which locking part 223 of second coupler 22 is locked. When locking part 223 is locked to locked part 213, second coupler 22 is prevented from coming off from first coupler 21.

In the present exemplary embodiment, paired locking parts 223 are formed on respective sides of second coupler 22 in the Y-direction. Each of locking parts 223 includes arm part 2231 extending downward from an end of bottom wall 221 in the Y-direction, and locking claw 2232 provided continuously at a lower end of arm part 2231 while protruding outward in the Y-direction. In contrast, paired locked parts 213 to which respective locking parts 223 are locked is formed on respective sides of first coupler 21 in the Y-direction. Each of locked parts 213 includes locking wall 2131 provided with through-hole 2132 passing through locking wall 2131 in the Z-direction.

A leading end (more specifically, a lower end) of arm part 2231 is inserted into through-hole 2132 to lock locking claw 2232 to a lower surface of locking wall 2131 in a frame shape, so that second coupler 22 is prevented from being moved further upward from first coupler 21 in the Z-direction. As described above, in the present exemplary embodiment, locking claw 2232 is locked to the lower surface of locking wall 2131 having a frame shape to restrict upward relative movement of second coupler 22 from first coupler 21. In the present embodiment, downward movement of locking claw 2232 from the lower surface of locking wall 2131 is not restricted. This configuration allows second coupler 22 to be floated from first coupler 21 with an upper limit (referred to below as a “top dead center”) at a position where locking claw 2232 is locked to the lower surface of locking wall 2131. In the present exemplary embodiment, head part 30 has a bottom dead center at which second coupler 22 is moved downward relative to first coupler 21 and second coupler 22 comes into contact with first coupler 21.

Peripheral wall 222 of second coupler 22 is provided in its upper part with shaft holder 2221 for holding shaft 25 for swinging third coupler 23 in the left-right direction (i.e., the Y-direction).

In the present exemplary embodiment, peripheral wall 222 is provided in its upper parts (i.e., upper parts of front and rear walls) on respective sides in the X-direction with paired shaft holders 2221 each having a substantially disk shape, and each of shaft holders 2221 is provided at its central part with insertion hole 2221a for inserting and holding shaft 25, insertion hole 2221a passing through the shaft holder in the X-direction.

Shaft 25 held by shaft holder 2221 couples second coupler 22 to third coupler 23 to allow third coupler 23 to be swung about shaft 25 in the left-right direction (i.e., the Y-direction) with respect to second coupler 22.

Thus, third coupler 23 is attached to first coupler 21 (i.e., one element of razor body 10) while being able to be not only floated in the Z-direction but also swung in the left-right direction (i.e., the Y-direction) with respect to first coupler 21 (i.e., one element of razor body 10).

In the present exemplary embodiment, third coupler 23 is formed by assembling multiple divided bodies, and includes lower divided body 231 attached to second coupler 22 while being able to be swung in the left-right direction (i.e., the Y-direction), and upper divided body 232 attached to an upper part of lower divided body 231. Third coupler 23 also includes intermediate divided body 233 sandwiched between lower divided body 231 and upper divided body 232.

Lower divided body 231 includes base part 2311. Base part 2311 is provided at its central part with through-hole 23111 passing through the central part in the Z-direction (i.e., the up-down direction), so that a lead wire or the like can be inserted through base part 2311.

Base part 2311 is also provided at its opposite ends in the X-direction with respective shaft holders 2312 paired, and each of shaft holders 2312 is formed of two wall parts disposed away from each other in the X-direction. The two wall parts are each provided with hole 2312a into which shaft 25 is inserted. In the present exemplary embodiment, the two wall parts include a first wall part which is formed outside in the X-direction and which is provided with first hole 2312a passing through the first wall part in the X direction, and a second wall part which is formed inside in the X-direction and which is provided with second hole 2312a that opens outward in the X-direction but does not pass through the second wall part in the X-direction. This configuration restricts inward movement of shaft 25 in the X-direction with the second wall part formed inside in the X-direction.

Shaft 25 is inserted into each of holes 2221a and 2312a in a state where shaft holder 2221 of second coupler 22 is inserted between the two wall parts disposed away from each other in the X-direction, so that lower divided body 231 is attached to second coupler 22 while being able to be swung in the left-right direction (i.e., the Y direction) about shaft 25.

At this time, lower divided body 231 is attached to second coupler 22 with coil springs 26 interposed between second coupler 22 and lower divided body 231. Thus, base part 2311 of lower divided body 231 is provided at its opposite ends in the Y-direction in its lower surface with respective spring receiving projections 23112 protruding downward as illustrated in FIG. 8. Second coupler 22 is provided with spring receiving projection 2213 which protrudes upward, as illustrated in FIG. 6. Upper and lower ends of a pair of coil springs 26 are inserted into corresponding spring receiving projections 2213 and 23112.

When lower divided body 231 is swung with coil springs 26 interposed as described above, base part 2311 of lower divided body 231 can be maintained horizontally in a free state where no force is applied to lower divided body 231.

In contrast, upper divided body 232 is a member fixed to lower divided body 231 with screw 27 while intermediate divided body 233 is sandwiched between upper divided body 232 and lower divided body 231, and includes base part 2321. Base part 2321 is provided at its central part with through-hole 23211 passing through the central part in the Z-direction (i.e., the up-down direction), so that a lead wire or the like can be inserted through base part 2321.

Base part 2321 is provided at its opposite ends in the X-direction with respective paired hanging walls 2322 continuously provided downward, and each of hanging walls 2322 is provided with slit 23221 that opens downward and inward in the X-direction while extending in the Z-direction, as illustrated in FIG. 8. An outer end of shaft 25 in the X-direction is inserted into slit 23221 when upper divided body 232 is attached to lower divided body 231. This configuration restricts outward movement of shaft 25 in the X-direction with hanging walls 2322.

Intermediate divided body 233 is sandwiched between upper divided body 232 and lower divided body 231 while being allowed to be moved in the up-down direction. Then, operation part 113 illustrated in FIG. 3 is operated to move intermediate divided body 233 upward, so that head part 30 is fixed by intermediate divided body 233. This configuration enables restricting relative movement of head part 30 with respect to razor body 10.

Coupling mechanism 20 includes link mechanism 28 for swinging head part 30 in the X-direction, and link mechanism 28 is attached to third coupler 23.

As described above, link mechanism 28 for swinging head part 30 in the X-direction is provided in third coupler 23 that can be vertically floated and horizontally swung with respect to first coupler 21 (i.e., one element of razor body 10), so that head part 30 can be separately and independently moved in three directions (i.e., the X-direction, the Y-direction, and the Z-direction) relatively with respect to first coupler 21 (i.e., one element of razor body 10).

Third coupler 23 is provided on its opposite side in the Y-direction with respective paired link mechanisms 28 in the present embodiment, so that paired link mechanisms 28 are connected to respective sides of head part 30 in the Y-direction to allow head part 30 to be swung in the X-direction with respect to third coupler 23.

Each link mechanism 28 includes one fixed link 281 fixed to third coupler 23 and a pair of movable links 282 attached to one fixed link 281 while being rotatable in the X-direction.

In the present exemplary embodiment, fixed link 281 includes fixture 2811 fixed to third coupler 23, support arm 2812 connected to fixture 2811, and pivot part 2813 formed at an upper end of support arm 2812 to allow movable link 282 to be attached to pivot part 2813 while being rotatable in the X-direction.

In contrast, movable link 282 includes link body 2821, coupling shaft part 2822 provided at one end of link body 2821 and rotatably attached to pivot part 2813 of fixed link 281, and connection end part 2823 provided at the other end of link body 2821 and connected to head part 30.

Fixture 2811 of fixed link 281 is provided with through-hole 2811a passing through fixture 2811 in the Z-direction. Lower divided body 231 and upper divided body 232 are coupled to each other with fixture 2811 interposed between lower divided body 231 and upper divided body 232 while screw 27 is inserted into through-hole 2811a, so that fixed link 281 is fixed to third coupler 23.

Support arm 2812 includes a lateral wall extending outward in the Y-direction, and a longitudinal wall provided continuously with the lateral wall and extending upward (i.e., an upper side in the Z-direction), and pivot part 2813 is formed at an upper end of the longitudinal wall of support arm 2812. Pivot part 2813 is formed extending from an upper end of the longitudinal wall of support arm 2812 to both sides in the X-direction, and two through-holes 2813a are provided in pivot part 2813 while passing through pivot part 2813 in the Y-direction and aligning in the X direction. Coupling shaft parts 2822 of the pair of movable links 282 are inserted into two respective through-holes 2813a, so that the pair of movable links 282 is attached to one fixed link 281 while being rotatable in the X-direction.

In the present exemplary embodiment, upper divided body 232 according to includes extension wall 2323 extending outward in the Y-direction, and the lateral wall of support arm 2812 is held by extension wall 2323. This configuration suppresses positional displacement of fixed link 281 with respect to third coupler 23.

Third coupler 23 also includes cover 234 attached to extension wall 2323, and the lateral wall of support arm 2812 is covered with cover 234 and extension wall 2323. This configuration suppresses exposure of the lateral wall of support arm 2812 to the outside to improve design of electric razor 1. Link mechanism 28 is connected to head part 30 inside head part 30 according to the present exemplary embodiment, so that link mechanism 28 can be prevented from being exposed to the outside as much as possible. This configuration further enhances the design of electric razor 1.

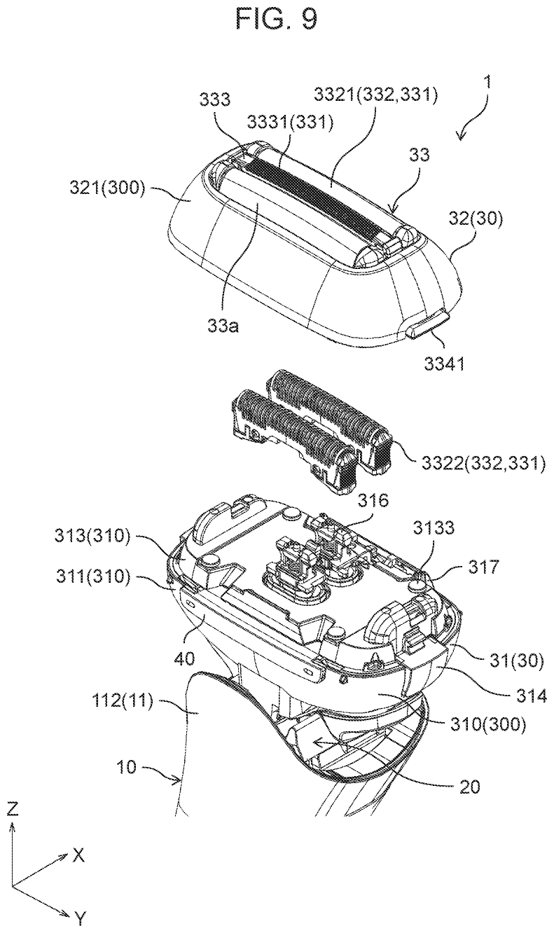

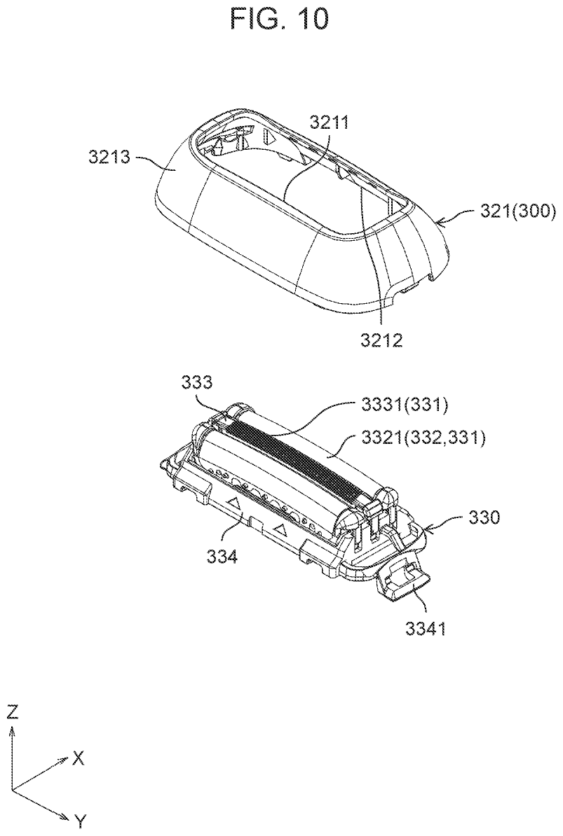

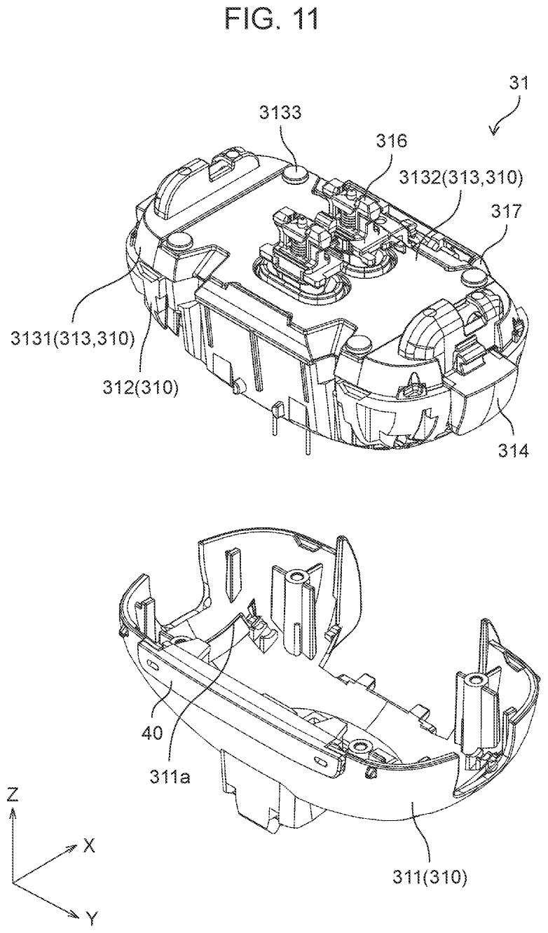

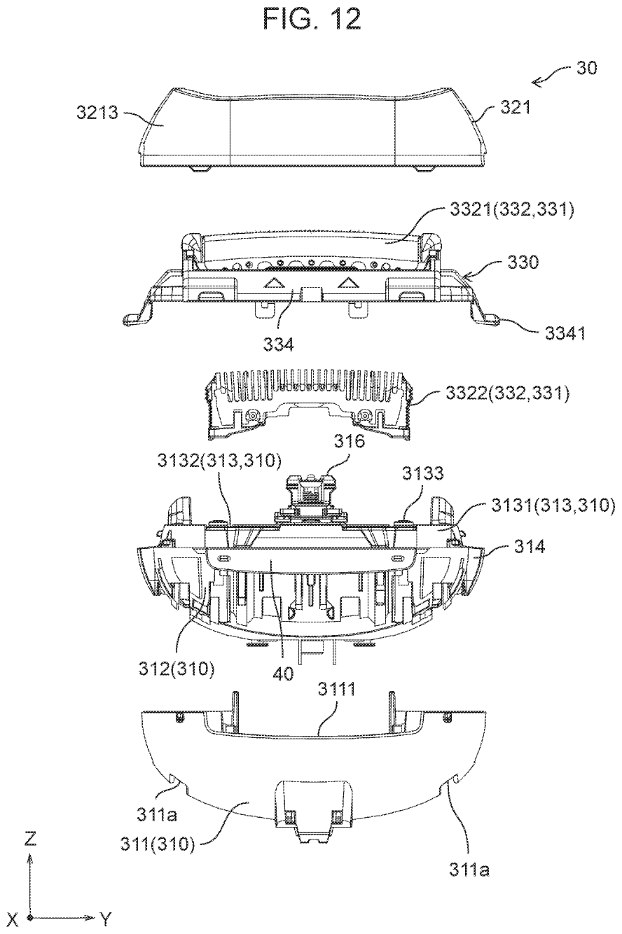

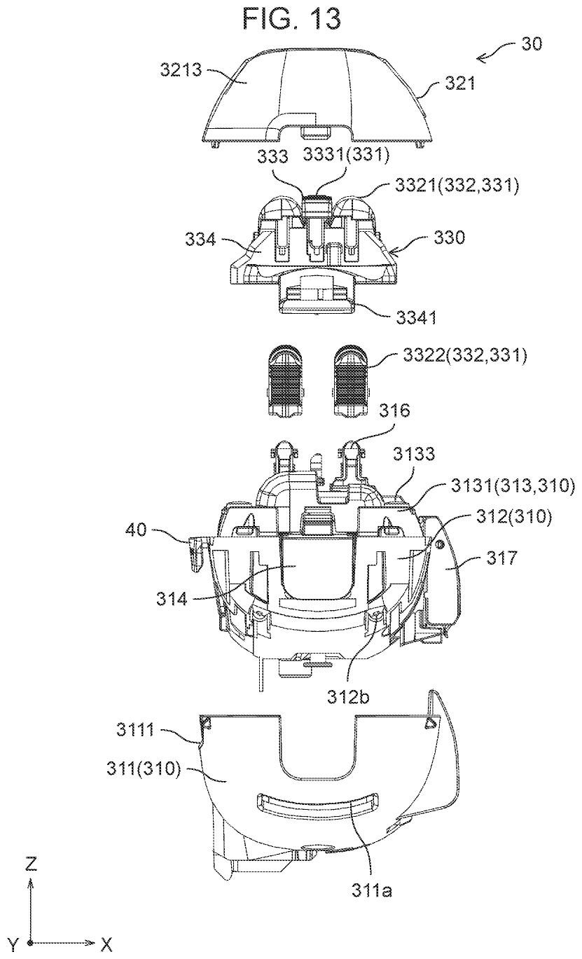

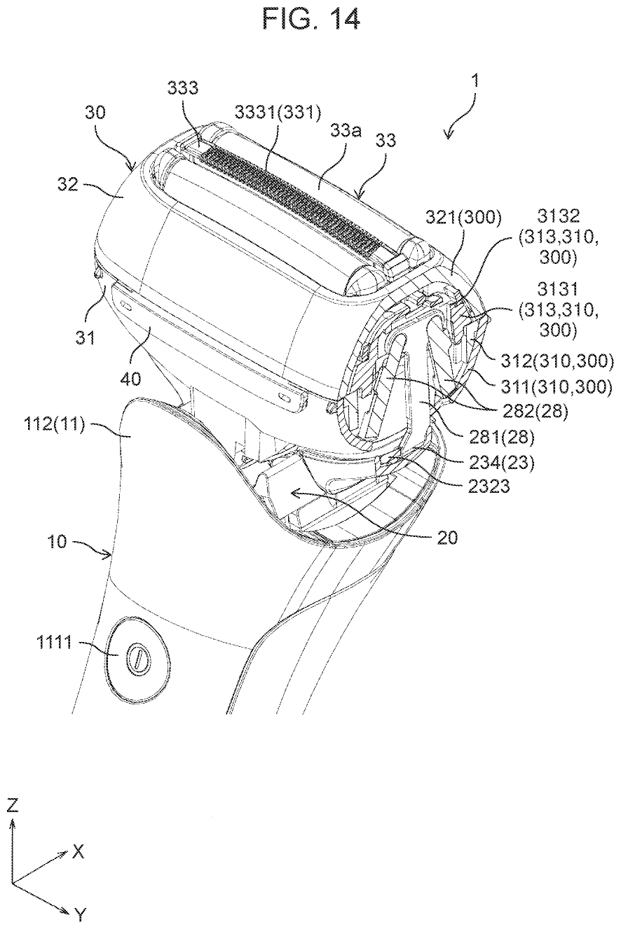

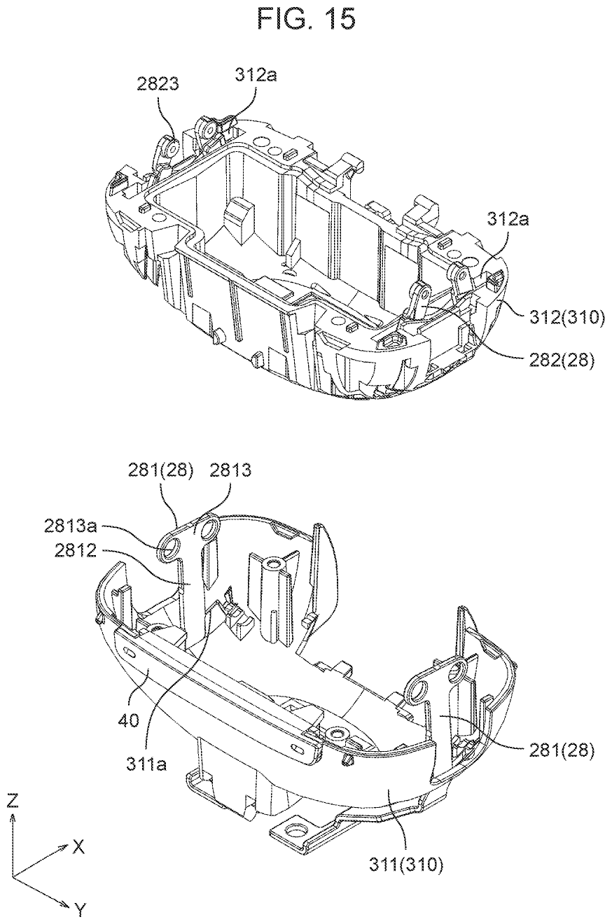

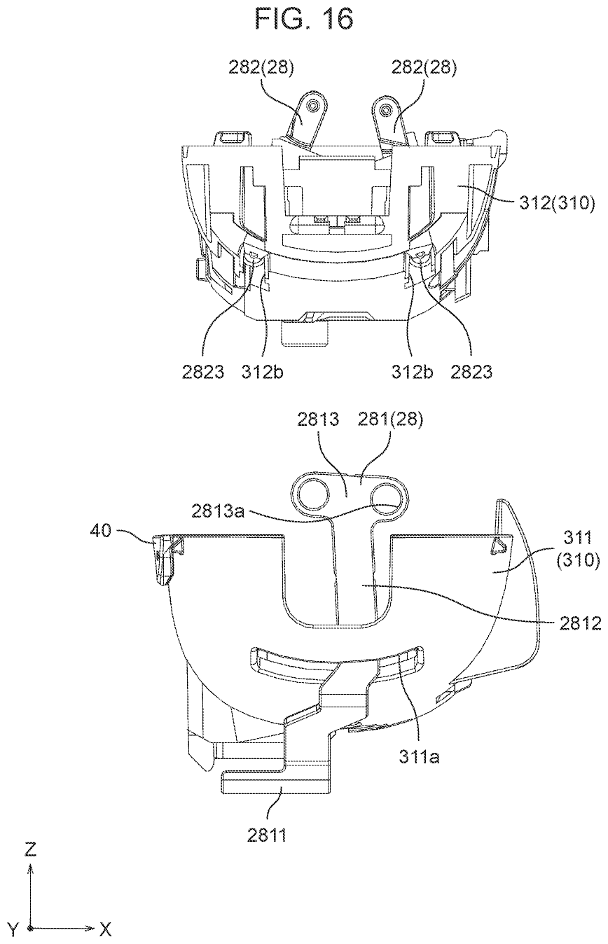

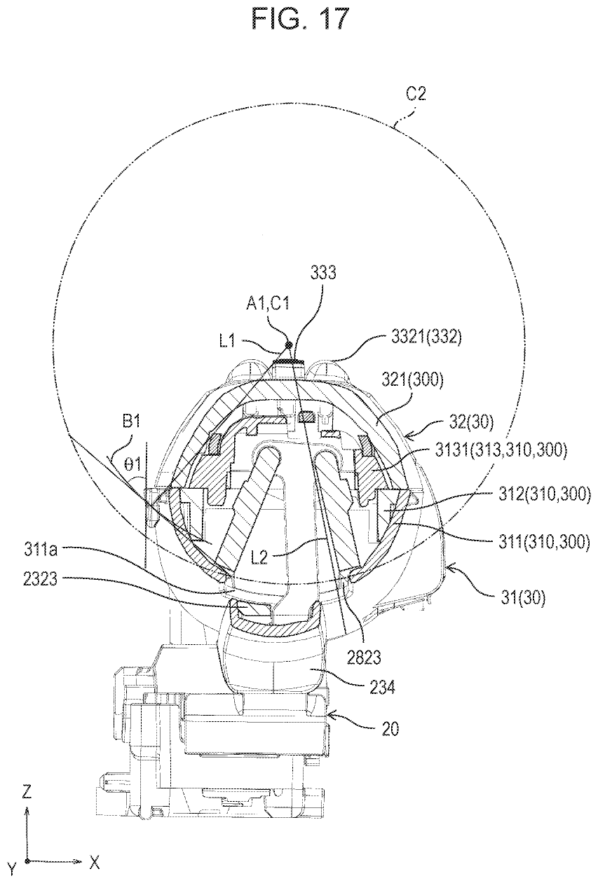

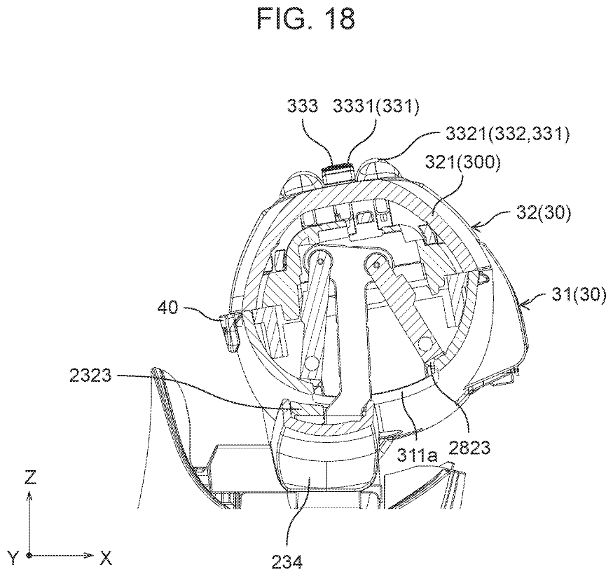

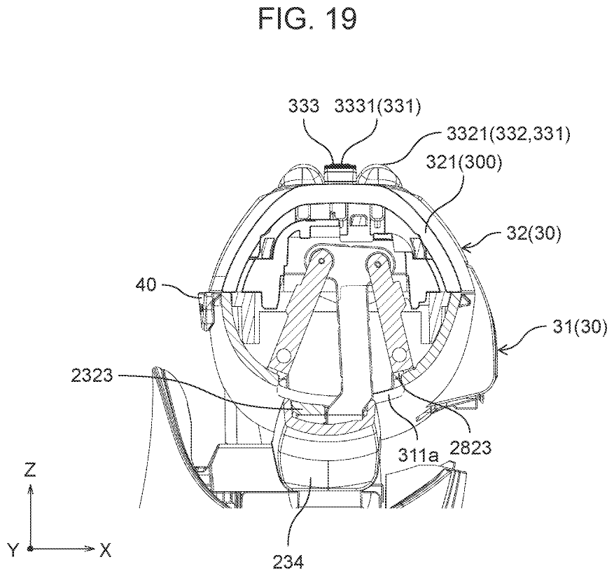

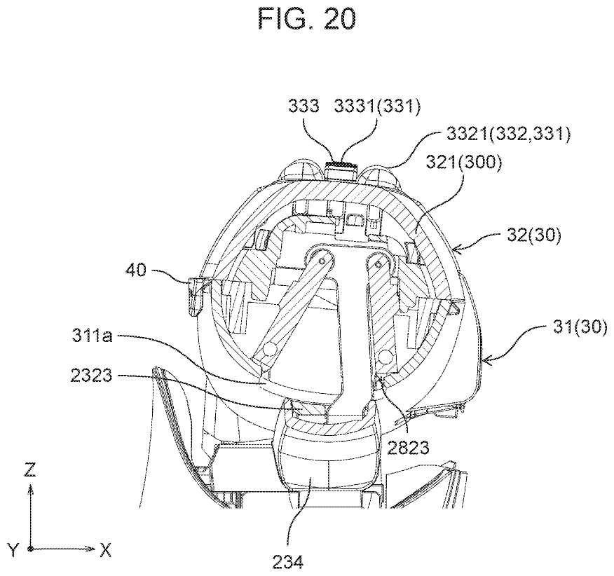

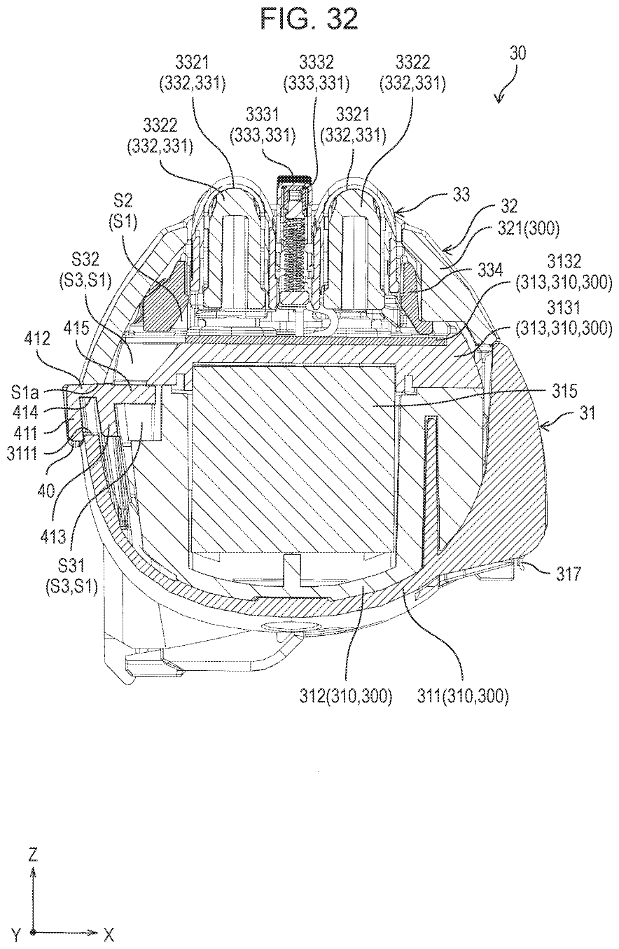

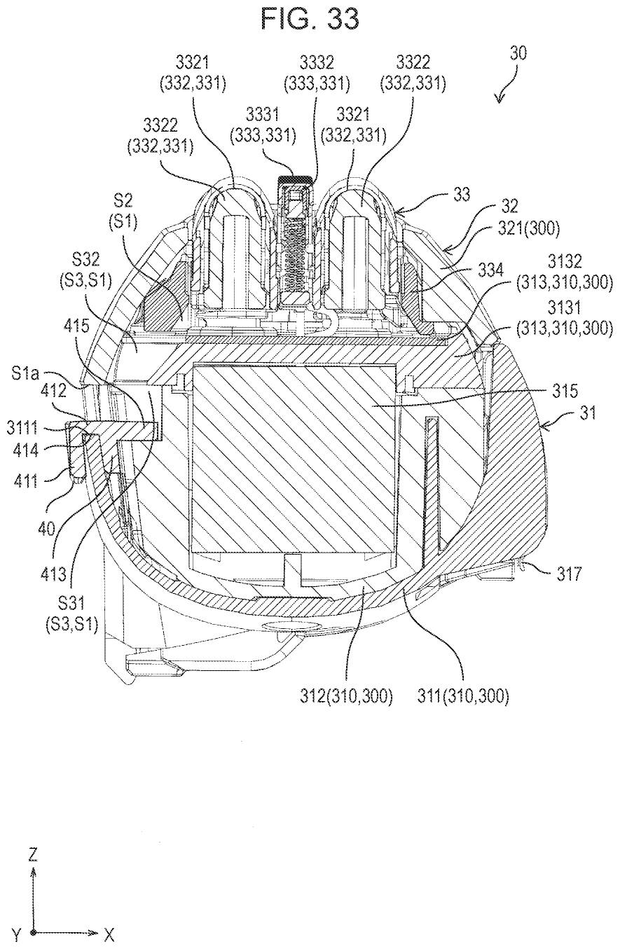

Next, a specific configuration of head part 30 will be described with reference to FIGS. 9 to 20, 32, and 33. FIG. 9 is a partially exploded perspective view of head part 30 of electric razor 1. FIG. 10 is an exploded perspective view illustrating head cover part 32 of head part 30. FIG. 11 is an exploded perspective view illustrating head base part 31 of head part 30. FIG. 12 is an exploded front view of head part 30. FIG. 13 is an exploded side view of head part 30. FIG. 14 is a partially cutaway perspective view of electric razor 1. FIG. 15 is a perspective view for illustrating a method for coupling head part 30 to link mechanism 28. FIG. 16 is a side view for illustrating a method for coupling head part 30 to link mechanism 28. FIG. 17 is a cross-sectional view illustrating a coupling state between head part 30 and link mechanism 28. FIG. 18 is a cross-sectional view illustrating swing of head part 30 in a front-rear direction, the cross-sectional view illustrating a state in which head part 30 is located on a foremost side. FIG. 19 is a cross-sectional view illustrating swing of head part 30 in the front-rear direction, the cross-sectional view illustrating a state in which head part 30 is located at a central part. FIG. 20 is a cross-sectional view illustrating swing of head part 30 in the front-rear direction, the cross-sectional view illustrating a state in which head part 30 is located on a rearmost side. FIG. 32 is a cross-sectional view illustrating head part 30 when lid part 40 is closed. FIG. 33 is a cross-sectional view illustrating head part 30 when lid part 40 is opened.

In the present exemplary embodiment, head part 30 includes head housing 300, and blade unit 33 that has blade part 331 and that is detachably attached to head housing 300. Blade unit 33 is held by head housing 300 in a state where a part of blade part 331 is exposed to the outside. This configuration allows a part of blade part 331 exposed to the outside of head housing 300 to function as skin contact surface 33a that comes into contact with the skin of a user or the like when electric razor 1 is used.

Movable link 282 of link mechanism 28 is connected to head housing 300 to rotate movable link 282 relative to fixed link 281, so that head part 30 is swung in the X-direction with respect to razor body 10.

In the present exemplary embodiment, head part 30 is configured to be divided into multiple members as illustrated in FIG. 9, and includes head base part 31 attached to coupling mechanism 20 and head cover part 32 detachably attached to head base part 31. In the present exemplary embodiment, head base part 31 is provided at its right and left ends with respective release buttons 314 that can protrude and retract, and attachment of head cover part 32 to head base part 31 is released by pressing release buttons 314 inward.

Head base part 31 includes base housing 310, and base housing 310 is a lower housing of head housing 300 in the present exemplary embodiment.

As illustrated in FIG. 11, base housing 310 includes outer housing 311 that opens upward and has an accommodation space formed inside, and inner housing 312 that is accommodated in the accommodation space of outer housing 311. Inner housing 312 also opens upward, and an accommodation space is also formed inside inner housing 312.

In the present exemplary embodiment, base housing 310 includes top wall 313, and an upper opening of inner housing 312 is covered with top wall 313. Top wall 313 includes top wall body 3131 that closes the upper opening of inner housing 312 and press plate 3132 that presses top wall body 3131 from above. Top wall body 3131 and press plate 3132 are attached to inner housing 312 with screw 3133.

As illustrated in FIGS. 32 and 33, drive mechanism 315 is accommodated in a space defined by inner housing 312 and top wall 313. Drive mechanism 315 includes multiple drive columns 316 (see FIGS. 9 and 12), and is accommodated in head base part 31 in a state where drive columns 316 protrudes upward from head base part 31. As drive mechanism 315 described above, conventionally known available examples include a linear actuator of a vibration type, and a drive mechanism including a rotary motor and a conversion mechanism that converts rotational motion into reciprocating linear motion.

Inner housing 312 is attached to outer housing 311 while top wall 313 is attached to inner housing 312 in a state where inner housing 312 is accommodated in a space of outer housing 311 and drive mechanism 315 is accommodated in inner housing 312, thereby forming head base part 31. As illustrated in FIG. 11, in the present exemplary embodiment, inner housing 312 is attached to outer housing 311 with screw 3133, screw 3133 being used when top wall body 3131 and press plate 3132 are attached to inner housing 312. That is, top wall body 3131, press plate 3132, inner housing 312, and outer housing 311 are fixed with screws 3133. Assembly procedure of head base part 31 is not limited to the procedure described above, and head base part 31 can be assembled by various procedures.

Here, in the present exemplary embodiment, head part 30 is allowed to be swung in the X-direction with respect to razor body 10 by connecting link mechanism 28 to head base part 31. At this time, link mechanism 28 is connected to head base part 31 inside head base part 31.

Specifically, slits 311a extending in the X-direction are provided on respective sides of outer housing 311 in the Y-direction as illustrated in FIGS. 14 to 17. Slit 311a formed as described above enables support arm 2812 (more specifically, the longitudinal wall of support arm 2812) of fixed link 281 to be inserted into slit 311a from below. A hole into which support arm 2812 is inserted is formed in a slit shape, so that head part 30 can be swung in the X-direction without interfering with support arm 2812.

As illustrated in FIG. 15, inner housing 312 is provided on its opposite sides in the Y-direction with respective slits 312a passing through inner housing 312 in the Z-direction. Slit 312a formed as described above enables link body 2821 close to coupling shaft part 2822 (see FIG. 8) of movable link 282 to be inserted into slit 312a from below.

As illustrated in FIG. 16, inner housing 312 is also provided on its opposite sides in the Y-direction with connection recesses 312b that are formed in its respective lower parts on opposite sides in the X-direction. Connection end part 2823 (see FIG. 8) is introduced into connection recess 312b while link body 2821 close to coupling shaft part 2822 is inserted into slit 312a, so that inner housing 312 is placed on movable link 282. This configuration allows movable link 282 to be connected to inner housing 312.

Here, in the present exemplary embodiment, movable link 282 is allowed to be connected to fixed link 281 in the state described above. That is, coupling shaft part 2822 is inserted into through-hole 2813a of pivot part 2813 in a state where inner housing 312 in which connection end part 2823 is connected to connection recess 312b while link body 2821 close to coupling shaft part 2822 is inserted into slit 312a is accommodated in outer housing 311 in which support arm 2812 of fixed link 281 is inserted into slit 311a, so that movable link 282 is coupled to fixed link 281.

This configuration allows link mechanism 28 to be connected to head part 30 inside head part 30. Head part 30 is supported by razor body 10 using link mechanism 28, so that head part 30 swings in the X-direction with virtual axis μl extending in the Y-direction as rotation center C1 as illustrated in FIG. 17. In the present exemplary embodiment, when head part 30 is viewed in the Y-direction, virtual axis μl serving as rotation center C1 is located above (i.e., outward of) head part 30 as illustrated in FIG. 17. This configuration allows the whole of head part 30 to be moved toward the same side in the X-direction (i.e., a front side or a rear side) when head part 30 is swung in the X-direction as illustrated in FIGS. 18 to 20.

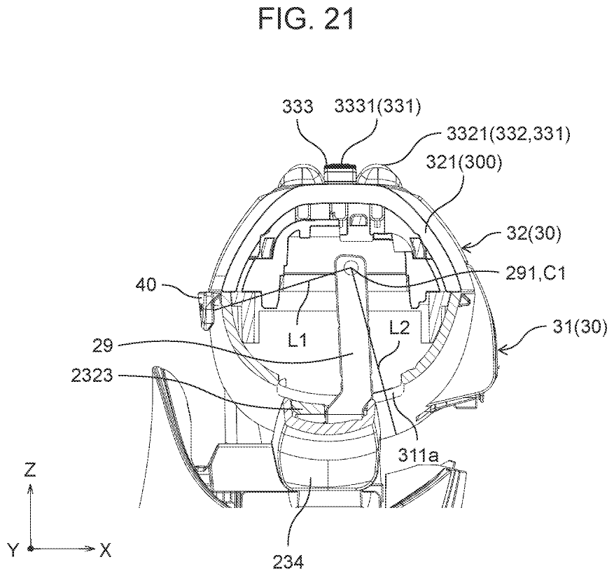

Although head part 30 supported at two points in a side view (i.e., a state viewed in the Y-direction) is exemplified in the present exemplary embodiment, head part 30 may be supported at one point as illustrated in FIG. 21. FIG. 21 is a cross-sectional view illustrating a modification of a method for supporting head part 30 being capable of swinging. Specifically, head part 30 is coupled to shaft 291 formed at an upper end of support member 29 extending in the up-down direction. Thus, when head part 30 is supported at one point in a side view (i.e., a state viewed in the Y-direction), shaft 291 aligns with rotation center C1 of head part 30.

As illustrated in FIG. 10, head cover part 32 includes cover housing 321, and cover housing 321 is an upper housing of head housing 300 in the present exemplary embodiment. Blade unit 33 is attached to cover housing 321 to form head cover part 32.

Next, a specific configuration of blade unit 33 will be described with reference to FIGS. 9 to 13, 32, and 33.

Blade unit 33 includes three blade blocks and outer blade case 334, and the three blade blocks are disposed side by side in the X-direction with their longitudinal directions aligning with the Y-direction.

As described above, in the present exemplary embodiment, each of the blade blocks has a predetermined length and width, and these blade blocks are each disposed in a state where the length direction thereof is substantially aligning with the Y-direction (i.e., the second direction or the left-right direction) of electric razor 1 and where the width direction thereof is substantially aligning with the X-direction (i.e., the first direction, front-back direction, or shaving direction) of electric razor 1.

In the present exemplary embodiment, the three blade blocks include two net blade blocks 332 and one slit blade block 333.

Net blade block 332 mainly has a function of cutting off beard in a fallen state (i.e., an example of body hair in a fallen state) and beard in a short standing state (i.e., an example of body hair in a short standing state). Slit blade block 333 mainly has a function of cutting off thin long beard (i.e., an example of thin long body hair). Thus, electric razor 1 according to the present exemplary embodiment is a depilatory device capable of cutting off thin long beard (i.e., an example of thin long body hair) with slit blade block 333 and then finishing the beard with net blade block 332.

In the present exemplary embodiment, one slit blade block 333 is disposed at the center in the X-direction and two net blade blocks 332 are disposed on respective sides across slit blade block 333.

As illustrated in FIG. 9, in the present exemplary embodiment, net blade block 332 includes net blade 3321 and inner net blade 3322. Net blade 3321 is formed by being curved in an inverted U-shape convex upward in a side view (i.e., a state viewed in the Y-direction).

Net blade 3321 is also formed by being slightly curved in the Y-direction (i.e., outer blade length direction) to be convex upward in a front view (i.e., a state viewed in the X-direction). For example, many circular blade holes (not illustrated) are formed in net blade 3321. Net blade 3321 may be formed without being curved to be convex upward in the front view. For example, when net blade 3321 is viewed from the front (i.e., a state viewed in the X-direction), the top of net blade 3321 may be a straight line extending in the Y-direction (i.e., outer blade length direction).

Inner net blade 3322 has an inverted U-shape along a curved shape of net blade 3321, and is disposed inside net blade 3321 (i.e., below net blade 3321, a side opposite to a side of net blade 3321 in contact with the skin). Inner net blade 3322 is detachably attached to one drive column 316 of multiple drive columns 316. When the power supply of electric razor 1 is turned on to drive drive column 316 in a state where inner net blade 3322 is disposed inside net blade 3321 while being attached to drive column 316, inner net blade 3322 is displaced relative to net blade 3321 (i.e., relative movement, or reciprocating in the Y-direction) while being in sliding contact with an inner surface of net blade 3321.

As illustrated in FIGS. 32 and 33, in the present exemplary embodiment, slit blade block 333 includes slit outer blade 3331 and slit inner blade 3332. slit outer blade 3331 is formed by being bent in an inverted U-shape convex upward in a side view (i.e., a state viewed in the Y-direction). Slit outer blade 3331 is formed with a top surface that is substantially flat in the side view (i.e., a state viewed in the Y-direction).

Slit outer blade 3331 is also formed by being slightly curved in the Y-direction (i.e., outer blade length direction) to be convex upward in a front view (i.e., a state viewed in the X-direction). Slit outer blade 3331 is provided with multiple blade holes that are each in a slit shape extending in the X-direction and are spaced apart in the Y-direction. Slit outer blade 3331 may be formed without being curved to be convex upward in the front view. For example, when slit outer blade 3331 is viewed from the front (i.e., a state viewed in the X-direction), the top of slit outer blade 3331 may be a straight line extending in the Y-direction (i.e., outer blade length direction). That is, slit outer blade 3331 can be formed with a top surface that is a plane (i.e., a flat surface).

Slit inner blade 3332 has an inverted U-shape along a bent shape of slit outer blade 3331, and is disposed inside slit outer blade 3331 (i.e., below slit outer blade 3331, a side opposite to a side of slit outer blade 3331 in contact with the skin). Slit inner blade 3332 is detachably attached to one drive column 316 of multiple drive columns 316 (i.e., drive column 316 different from the drive column to which inner net blade 3322 is attached). When the power supply of electric razor 1 is turned on to drive drive column 316 in a state where slit inner blade 3332 is disposed inside slit outer blade 3331 while being attached to drive column 316, slit inner blade 3332 is displaced relative to slit outer blade 3331 (i.e., relative movement, or reciprocating in the Y-direction) while being in sliding contact with an inner surface of slit outer blade 3331.

As described above, electric razor 1 according to the present exemplary embodiment has a form of a reciprocating electric razor in which inner net blade 3322 and slit inner blade 3332 are reciprocated with respect to net blade 3321 and slit outer blade 3331, respectively. Thus, in the present exemplary embodiment, blade part 331 includes three outer blades (i.e., two net blades 3321 and one slit outer blade 3331) and three inner blades (i.e., two inner net blades 3322 and one slit inner blade 3332).

In the present exemplary embodiment, members other than two inner net blades 3322 of the three blade blocks are allowed to be attached to outer blade case 334 in a substantially frame shape. At this time, each of the members may be detachably attached to outer blade case 334, or may be attached to outer blade case 334 while being undetachable.

Also in the present exemplary embodiment, two net blade blocks 332 and one slit blade block 333 are allowed to be attached to outer blade case 334 while being able to be floated in the Z-direction (i.e., the up-down direction). Thus, when cover housing 321 (i.e., one element of head cover part 32) to which outer blade cassette 330 has been attached is attached to head base part 31, each blade block is floated separately and independently from head part 30. One or more blade blocks of two net blade blocks 332 and one slit blade block 333 may be configured not to be floated in the Z-direction (i.e., the up-down direction).

Furthermore, as illustrated in FIG. 9, in the present exemplary embodiment, two net blades 3321 can be attached to outer blade case 334 while being provided inside with no inner net blade 3322. In contrast, one slit outer blade 3331 is attached to outer blade case 334 while being provided inside with slit inner blade 3332. As described above, in the present exemplary embodiment, outer blade cassette 330 is formed by attaching two net blades 3321 and one slit blade block 333 to outer blade case 334. Then, outer blade cassette 330 is detachably attached to cover housing 321.

Specifically, cover housing 321 includes peripheral wall part 3213 in a substantially tubular shape in which upper opening 3211 and lower opening 3212 are formed, and outer blade cassette 330 with each outer blade facing upward is inserted from lower opening 3212 of cover housing 321 to attach outer blade cassette 330 to cover housing 321. At this time, outer blade cassette 330 is attached to cover housing 321 while a surface of each outer blade is exposed from upper opening 3211 of cover housing 321. Thus, in the present exemplary embodiment, a part of the surface of each outer blade exposed from upper opening 3211 of cover housing 321 is a part of blade part 331 exposed to the outside of head housing 300. That is, the part of the surface of each outer blade exposed from upper opening 3211 of cover housing 321 serves as skin contact surface 33a that comes into contact with the skin of the user (hereinafter, the skin of the user may be referred to as a “skin surface”).

Outer blade case 334 is provided at its left and right ends with respective release buttons 3341, and release buttons 3341 are operated to release attachment between cover housing 321 and outer blade cassette 330.

Head base part 31 (i.e., one element of head part 30) is provided behind with trimmer unit 317. This trimmer unit 317 can be provided in razor body 10 instead of head part 30, or can be configured not to be provided not only in head part 30 but also in razor body 10.

As described above, in the present exemplary embodiment, cover housing 321 to which outer blade cassette 330 has been attached is attached to head base part 31 in a state where two inner net blades 3322 are attached to corresponding drive columns 316 protruding upward from head base part 31. When cover housing 321 to which outer blade cassette 330 has been attached is attached to head base part 31 in a state where two inner net blades 3322 are attached to corresponding drive columns 316, two inner net blades 3322 are disposed inside corresponding net blades 3321.

This configuration allows each inner blade to be displaced (i.e., relative movement, reciprocating in the Y-direction) relative to the corresponding outer blade when the power supply of electric razor 1 is turned on.

Then, skin contact surface 33a of blade unit 33 is brought into contact with the skin of the user (i.e., the skin surface) and is moved while being slid in the X direction in a state where the power supply of electric razor 1 is turned on and each inner blade is displaced relative to the corresponding outer blade, so that beard (i.e., an example of hair) inserted into the blade hole of each outer blade is cut by the outer blade and the inner blade.

When head part 30 is assembled by attaching head cover part 32 to head base part 31, space S1 (see FIGS. 32 and 33) is formed inside head part 30, and beard (i.e., an example of hair) cut by the outer blade and the inner blade can be stored in space S1.

In the present exemplary embodiment, space S1 formed inside head part 30 is defined by outer housing 311, inner housing 312, top wall 313, cover housing 321, and skin contact surface 33a. Space S1 can be cleaned by detaching head cover part 32 from head base part 31.

In the present exemplary embodiment, space S1 is allowed to be cleaned without detaching head cover part 32 from head base part 31.

Specifically, head housing 300 is provided with opening window S1a communicating with space S1 in which cut beard can be stored. Opening window S1a is configured to function as an introduction port for introducing a liquid such as water or a washing liquid into space S1 when the beard (i.e., an example of hair) stored in space S1 is washed, and a discharge port for discharging the beard (i.e., an example of hair) or the liquid in space S1.

As illustrated in FIGS. 32 and 33, in the present exemplary embodiment, space S1 includes upper space S2 located above an upper surface of top wall 313, and space S3 in a groove shape located below upper space S2 and communicating with upper space S2. Opening window S1a is formed in head housing 300 to communicate with space S3 in a groove shape.

Specifically, top wall 313 is provided on its opposite sides in the Y-direction (i.e., in the left-right direction) on its front with respective slits inclined forward and downward, thereby forming paired inclined grooves S32 between top wall 313 and cover housing 321. Additionally, slits opening forward and extending in the up-down direction are provided at positions corresponding to inclined grooves S32 in front of inner housing 312, so that paired vertical grooves S31 communicating with corresponding inclined grooves S32 are formed between inner housing 312 and outer housing 311. As described above, in the present exemplary embodiment, paired spaces S3 each in a groove shape are formed on respective opposite sides in the Y-direction (i.e., in the left-right direction) on the front side of the inside of head housing 300 in a state where an upper part of each of spaces S3 communicates with upper space S2.

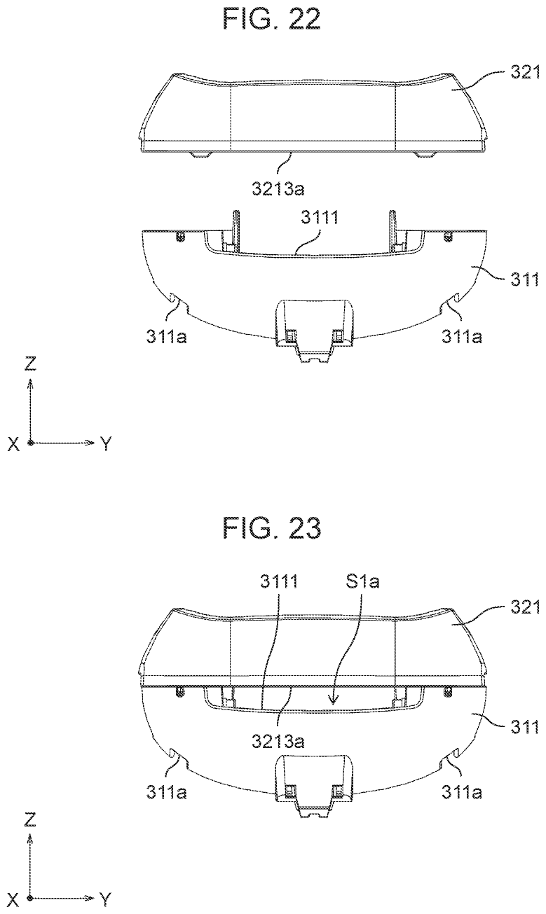

Outer housing 311 is provided at its upper front end with cutout 3111 recessed downward as illustrated in FIGS. 22 and 23, and when head cover part 32 is attached to head base part 31, opening window S1a is defined by cutout 3111 and lower end 3213a of cover housing 321. Here, FIG. 22 is a front view illustrating an example of a method for forming opening window S1a in head housing 300, the front view illustrating outer housing 311 and cover housing 321 that are disassembled. FIG. 23 is a front view illustrating an example of a method for forming opening window S1a in head housing 300, the front view illustrating opening window S1a defined by outer housing 311 and cover housing 321. In the present exemplary embodiment, top wall 313 is formed protruding upward from outer housing 311, and paired inclined grooves S32 are formed above an upper end of outer housing 311. Thus, opening window S1a defined by cutout 3111 provided at a front upper end of outer housing 311 while being recessed downward and lower end 3213a of cover housing 321 is formed below paired inclined grooves S32.

In the present exemplary embodiment, cutout 3111 is provided elongating in the Y-direction (i.e., in the left-right direction) to allow opening window S1a to have opposite sides in the Y-direction (i.e., in the left-right direction) communicating with respective paired spaces S3 each in a groove shape. Thus, in the present exemplary embodiment, opening window S1a opens forward in the front-rear direction (i.e., the X-direction, or the first direction) while facing vertical groove S31 below inclined groove S32.

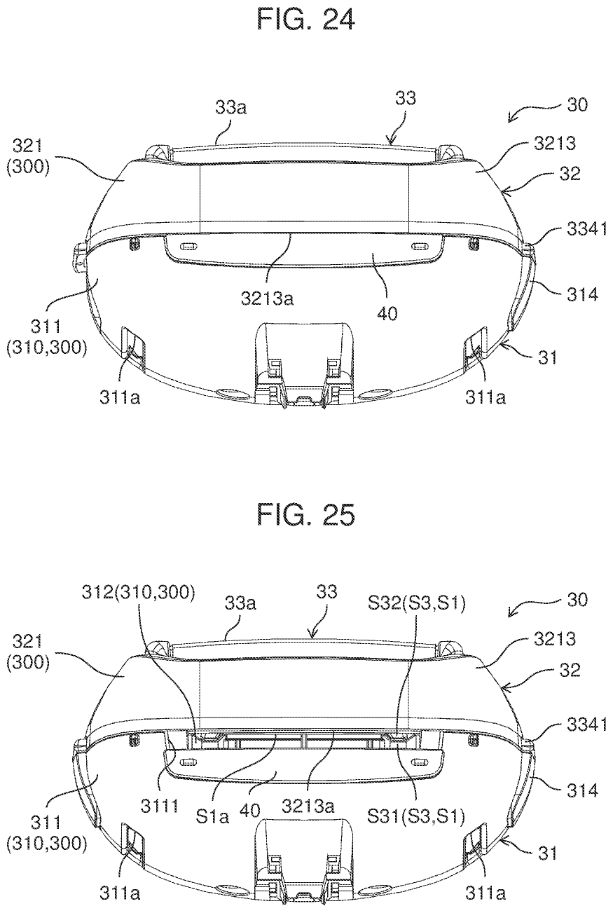

FIG. 24 is a perspective view illustrating head part 30 when lid part 40 is closed. FIG. 25 is a perspective view illustrating head part 30 when lid part 40 is opened. Lid part capable of covering opening window S1a is attached to head housing 300, and opening window S1a can be opened and closed by operating lid part 40 as illustrated in FIGS. 24 and Thus, liquid such as water can be introduced into space S1 through opening window S1a, or hair or liquid accumulated in space S1 can be discharged through opening window S1a only by operating lid part 40, so that space S1 can be cleaned without detaching head cover part 32 from head base part 31. This configuration enables cleaning the inside of space S1 more easily and introducing the liquid into space S1 more easily. In the present exemplary embodiment, lid part 40 is provided its opposite ends in the Y-direction (i.e., in the left-right direction) with respective operation parts 416, which will be described later, so that lid part 40 can be operated by hooking at least one of operation parts 416 with a finger.

In the present exemplary embodiment, opening window S1a is opened and closed by sliding lid part 40 along a surface of head housing 300 (i.e., an opening surface of opening window S1a). Specifically, lid part 40 is slid in a substantially up-down direction (i.e., in the Z-direction) to open or close opening window S1a. When lid part 40 is slid upward, opening window S1a is closed by lid part 40.

That is, when lid part 40 is slid upward to cover or close opening window S1a with lid part 40, space S1 is prevented from communicating with the outside through opening window S1a. This configuration prevents beard (i.e., an example of hair) accumulated in space S1 from spilling from opening window S1a to the outside when electric razor 1 is used or electric razor 1 is placed on a cleaning device.

In contrast, when lid part 40 is slid downward to prevent opening window S1a from being covered with lid part 40 (i.e., to opening window S1a), space S1 communicates with the outside through opening window S1a. This configuration enables not only introducing liquid such as water or cleaning liquid into space S1 through opening window S1a but also discharging beard (i.e., an example of hair) or the liquid in space S1 through opening window S1a when the beard (i.e., an example of hair) accumulated in space S1 is cleaned.

In the present exemplary embodiment, head part 30 is supported by razor body 10 in a state where the head part 30 is allowed to be reciprocated (more specifically, to be swung) relative to razor body 10 in the X-direction (i.e., the first direction).

Thus, when lid part 40 is moved along trajectory B1 drawn by lid part 40 during swing of head part 30 to perform opening and closing operation of lid part 40, force applied to lid part 40 directly serves as force for moving head part 30, and thus lid part 40 is less likely to be operated in its opening and closing direction.

In the present exemplary embodiment, opening and closing operability of lid part 40 is allowed to be further improved, even in electric razor 1 capable of relatively moving head part 30 with respect to razor body 10.

Specifically, as illustrated in FIG. 17, opening window S1a is opened and closed by lid part 40 by moving lid part 40 in a direction intersecting trajectory B1 drawn by lid part 40 when head part 30 is relatively reciprocated with respect to razor body 10 in the first direction (i.e., the X-direction).

Thus, the opening and closing operation of lid part 40 can be performed by applying force in the direction intersecting trajectory B1 to lid part 40. Then, when a force is applied to lid part 40 to open and close lid part 40, a component force in a direction along trajectory B1 is reduced as much as possible. This configuration enables head part 30 to be further prevented from moving relative to razor body 10 (i.e., body) in the first direction (i.e., the X-direction) when lid part 40 is opened or closed, thereby enabling further improvement in opening and closing operability of lid part 40.

Here, as described above, in the present exemplary embodiment, head part 30 is allowed to be swung in the X-direction while the whole of head part 30 is moved toward the same side in the X-direction. Thus, when head part 30 is swung in the X-direction, lid part 40 is swung in the X-direction while drawing an arc about virtual axis μl serving as rotation center C1. Thus, in the present exemplary embodiment, a part of a circle passing through lid part 40 about virtual axis μl is allowed to serve as trajectory B1 drawn by lid part 40 when head part 30 is reciprocated relative to razor body 10 in the X-direction. As illustrated in FIG. 17, trajectory B1 is an arc extending in the X-direction.

In according to the present exemplary embodiment, as described above, when head part 30 is viewed in the Y-direction, virtual axis μl serving as rotation center C1 is located above (i.e., outward of) head part 30. This configuration allows the whole of head part 30 to be moved forward in the front-rear direction when head part 30 is rotated forward in the front-rear direction, for example. Thus, even when lid part 40 is attached to any position of head housing 300, trajectory B1 drawn by lid part 40 is an arc extending in the X-direction. As described above, when virtual axis μl is located outside head part 30, trajectory B1 of lid part 40 is prevented from being changed in direction depending on an attachment place as in a case where virtual axis μl exists inside head part 30.

Thus, when lid part 40 is vertically slid (e.g., slid toward an upper end of cover housing 321 or slid toward a lower end of outer housing 311) to open or close opening window S1a (i.e., to open or close lid part 40), even lid part 40 attached to any position in a side part of head housing 300 enables lid part 40 to have an opening and closing direction intersecting trajectory B1.

Thus, in the present exemplary embodiment, lid part 40 is allowed to be vertically slid, thereby opening and closing opening window S1a, (i.e., opening and closing lid part 40). In the present exemplary embodiment, opening window S1a opens in the front-rear direction (i.e., the X-direction), so that opening window S1a and lid part 40 are formed on front and rear surfaces of head housing 300 that is swung in the front-rear direction (i.e., the X-direction). That is, opening window S1a and lid part 40 are formed on surfaces facing each other in a direction in which head housing 300 is moved (i.e., in a swing direction). This configuration enables lid part 40 to have an opening and closing direction intersecting trajectory B1 as long as lid part 40 is slid along the surfaces, even when lid part 40 is slid not only vertically but also in any direction. As described above, in the present exemplary embodiment, lid part 40 is allowed to have an opening and closing direction intersecting trajectory B1 more easily and reliably.

In the present exemplary embodiment, as described above, lid part 40 has a direction of its vertical slide close to the Z-direction that is substantially orthogonal to trajectory B1 extending in the X-direction. That is, opening window S1a and lid part 40 are each formed at a part with a trajectory drawn by vertical movement along the surface of head housing 300, the trajectory being substantially in the Z-direction.

In the present exemplary embodiment, head housing 300 has a substantially circular contour shape when head part 30 is viewed in the Y-direction (i.e., the second direction). Thus, when opening window S1a and lid part 40 are each formed at a central part in the up-down direction of head housing 300, lid part 40 has a vertical sliding direction close to the Z-direction. At this time, trajectory B1 and the opening and closing direction of lid part 40 preferably form angle θ1 within a range of 80 degrees to 100 degrees. As described above, angle θ1 formed closer to a right angle enables further reduction in component force in a direction along trajectory B1 generated when lid part 40 is opened and closed.

When trajectory B1 is curved as in the present exemplary embodiment, a tangent line of trajectory B1 at a position where lid part 40 is located and a direction in which lid part 40 is moved to be opened and closed at the position form angle θ1.

Angle θ1 formed by trajectory B1 and the opening and closing direction of lid part can be set within a range of 10 degrees to 170 degrees, but is preferably set within a range of 30 degrees to 150 degrees, and more preferably set within a range of 80 degrees to 100 degrees.

In the present exemplary embodiment, head housing 300 has a surface curved protruding outward, so that angle θ1 can be changed in size by vertically shifting positions where opening window S1a and lid part 40 are formed.

Furthermore, as illustrated in FIG. 17, in the present exemplary embodiment, distance L1 from rotation center C1 of head part 30 to lid part 40 is shorter than longest distance L2 (i.e., a distance from rotation center C1 to a lower end of head part 30) from rotation center C1 of head part 30.

This configuration enables lid part 40 to be located at a position closer to rotation center C1 of head part 30. Furthermore, in the present exemplary embodiment, lid part 40 exists inside virtual circle C2 about virtual axis μl, virtual circle C2 passing through connection end part 2823, when head part 30 is viewed in the Y-direction (i.e., the second direction).

This configuration enables lid part 40 to be located at a position close to virtual axis μl serving as rotation center C1 of head part 30, so that a component force in a direction along trajectory B1 is generated at a position close to rotation center C1 of head part 30 when a force is applied to lid part 40 to open and close lid part 40. This configuration also enables requiring a larger force to be applied to lid part 40 than when lid part 40 is located outside virtual circle C2 to swing head part 30 with the force applied to lid part 40 to open and close lid part 40. As a result, swing of head part 30 when lid part 40 is opened and closed can be further reduced, and lid part 40 can be further improved in opening and closing operability.

Even if a configuration illustrated in FIG. 21 is employed, it is preferable that distance L1 from rotation center C1 of head part 30 to lid part 40 is shorter than longest distance L2 (i.e., a distance from rotation center C1 to a lower end of head part 30) from rotation center C1 of head part 30. Thus, even when head part 30 is configured to be supported at one point, lid part 40 can be further improved in opening and closing operability.

In the present exemplary embodiment, head part 30 is supported by razor body 10 in a state where head part 30 is allowed to be swung relative to razor body 10 in the Y-direction (i.e., the second direction).

Thus, in the present exemplary embodiment, relative swing of head part 30 in the Y-direction (i.e., the second direction) with respect to razor body 10 is allowed to be further suppressed when lid part 40 is opened and closed.

Specifically, force required to relatively swing head part 30 with respect to razor body 10 in the Y-direction (i.e., the second direction) is increased more than ever before. The force required to swing head part 30 in the Y-direction (i.e., the second direction) can be adjusted by adjusting strength of coil spring 26, for example.

Furthermore, in the present exemplary embodiment, rotation center C3 when head part 30 is swung in the Y-direction (i.e., the second direction) is located lower than ever before.

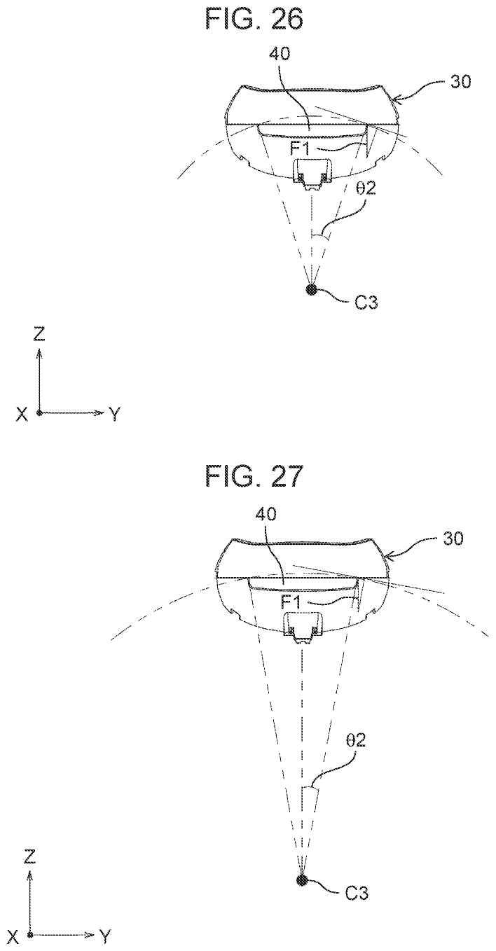

As described above, as illustrated in FIGS. 26 and 27, when rotation center C3 is located lower than ever before, angle θ2 formed by the vertical line and the straight line connecting rotation center C3 and an end of lid part 40 can be reduced more than ever before. Here, FIG. 26 is a front view illustrating a relationship between swing of head part in the left-right direction and opening and closing operation of lid part 40, the front view illustrating head part 30 according to a comparative example. FIG. 27 is a front view illustrating a relationship between swing of head part 30 in the left-right direction and opening and closing operation of lid part 40, the front view illustrating head part 30 according to an exemplary embodiment. As a result, component force (where the component force=F1×sin θ2) in a direction of force applied when head part 30 is swung in the Y-direction (i.e., the second direction) decreases, the force being generated when force F1 is applied to lid part 40 to open and close lid part 40. Here, the direction in which head part 30 is swung in the Y-direction (i.e., the second direction) is orthogonal to the straight line connecting rotation center C3 and the end of lid part 40.

As described above, when the component force in the direction of the force applied when head part 30 is swung in the Y-direction (i.e., the second direction) is reduced, swing of head part 30 in the second direction (i.e., the Y-direction) with respect to razor body 10 (i.e., the body) when lid part 40 is opened and closed can be further reduced. That is, when lid part 40 is opened and closed, head part 30 can be less likely to be swung in the second direction (i.e., the Y-direction). As a result, even when head part 30 is swung in the second direction (i.e., the Y-direction) with respect to razor body 10 (i.e., the body), lid part 40 can be further improved in opening and closing operability.

In the present exemplary embodiment, head part 30 is supported by razor body 10 while being floatable from razor body 10 in the Z-direction.

Thus, in the present exemplary embodiment, even when head part 30 is floated from razor body 10 in the Z-direction, lid part 40 is allowed to be further improved in opening and closing operability.

Specifically, when lid part 40 is slid (i.e., opening operation) downward, a float load of head part 30 in the Z-direction and an operation load during the opening operation of lid part 40 are adjusted to slide lid part 40 downward before head part 30 reaches the bottom dead center.

As described above, the amount of movement of lid part 40 during the opening operation is reduced by enabling lid part 40 to be slid downward before head part 30 reaches the bottom dead center. Thus, lid part 40 can be further improved in opening and closing operability.

In the present exemplary embodiment, head part 30 is located at the top dead center when electric razor 1 is not in use (i.e., no force is applied to head part 30), so that lid part 40 can be slid upward (i.e., the closing operation) without being affected by head part 30 being floated in the Z-direction.

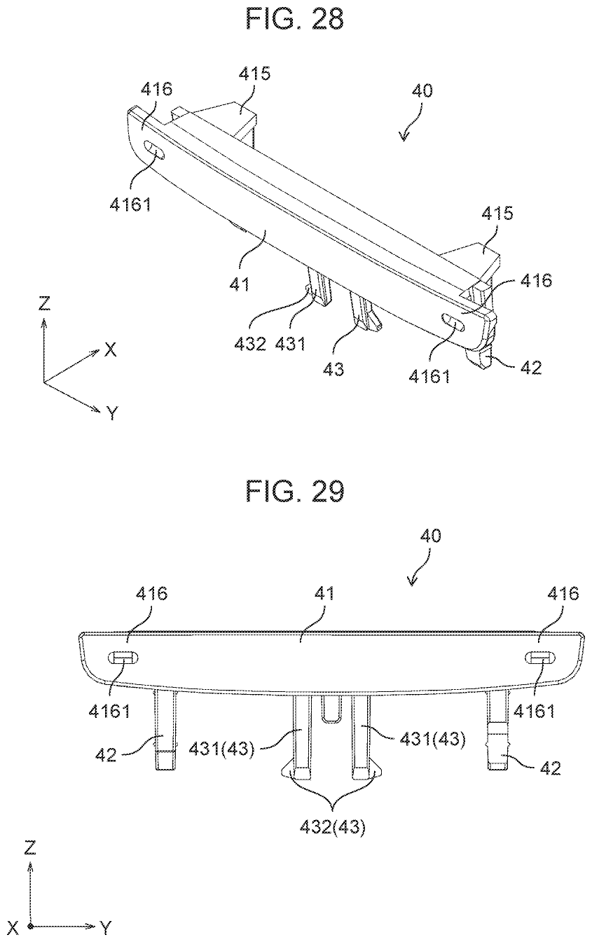

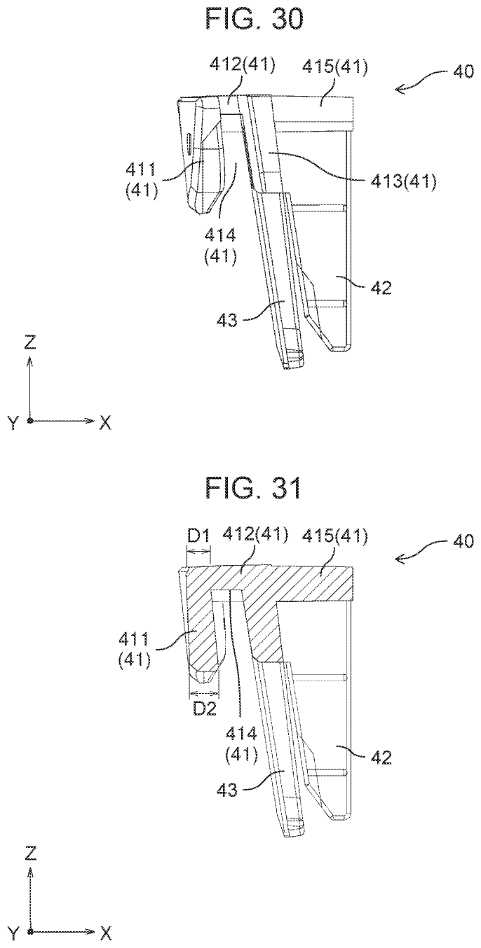

Next, a specific configuration of lid part 40 will be described with reference to FIGS. 28 to 33. FIG. 28 is a perspective view illustrating lid part 40. FIG. 29 is a front view illustrating lid part 40. FIG. 30 is a side view illustrating lid part 40. FIG. 31 is a cross-sectional view illustrating lid part 40. FIG. 32 is a cross-sectional view illustrating head part 30 when lid part 40 is closed. FIG. 33 is a cross-sectional view illustrating head part 30 when lid part 40 is opened.

As illustrated in FIGS. 30 and 31, in the present exemplary embodiment, lid part 40 includes lid body 41 that is openable and configured to cover opening window S1a. Lid body 41 includes front wall 411 having a substantially rectangular plate shape, rear wall 413 having a substantially rectangular plate shape, and coupling wall 412 that couples front wall 411 to rear wall 413 at their upper parts.

Between front wall 411 and rear wall 413, groove part 414 opened downward is formed. Groove part 414 is inserted into the upper end of outer housing 311 when opening window S1a is opened by operating lid part 40. Thus, lid part 40 is maintained in an open state.

Furthermore, lid part 40 is also provided with closing part 415 that is inserted into vertical groove S31 to close space S3 in a groove shape by vertically dividing space S3. As illustrated in FIG. 32, closing part 415 is formed in an upper part of lid part 40, and when lid part 40 is slid upward to close opening window S1a, a lower end of inclined groove S32 is closed by an upper surface of closing part 415. That is, space S1 is formed only above opening window S1a when opening window S1a is closed. This configuration prevents beard being cut (i.e., an example of hair being cut) from falling toward opening window S1a when opening window S1a is closed, and thus enables more reliable prevention of clogging of opening window S1a due to the beard being cut (i.e., an example of hair being cut), inhibition of downward sliding (i.e., the opening operation) of lid part 40 due to the being cut (i.e., an example of hair being cut), and the like.

Lid body 41 has a shape elongating in an intersecting direction (i.e., the Y direction) intersecting an opening and closing direction (i.e., the Z direction) of lid part 40. This configuration enables opening window S1a to be increased in opening area not only to introduce liquid such as water into space S1 through opening window S1a more efficiently, but also to discharge hair or liquid accumulated in space S1 through opening window S1a more efficiently.

As illustrated in FIG. 29, in the present exemplary embodiment, opposite ends in the Y-direction of lid body 41 having an elongated shape in the Y-direction serves as respective operation parts 416 for operating lid part 40 in the opening and closing direction (i.e., the Z-direction or the up-down direction). That is, lid body 41 is provided on its opposite sides in the Y-direction (i.e., the intersecting direction) with respective operation parts 416 for opening and closing lid part 40.

Here, as illustrated in FIGS. 32 and 33, in the present exemplary embodiment, lid part 40 is attached to head housing 300 in a state where at least a part of lid body 41 protrudes outward from head housing 300. Lid body 41 is provided on its opposite sides in the Y-direction (i.e., the intersecting direction) with respective parts protruding outward from head housing 300, and the parts are hooked by a nail (or a finger) to slide lid part 40 to open or close lid part 40.

Specifically, lid body 41 is provided at its lower ends on the opposite sides in the Y-direction (i.e., the intersecting direction) with respective parts protruding outward from head housing 300, and the parts are hooked by a nail (or a finger) to slide lid part 40 upward to close lid part 40.

In contrast, lid body 41 is provided at its upper ends on the opposite sides in the Y-direction (i.e., the intersecting direction) with respective parts protruding outward from head housing 300, and the parts are hooked by a nail (or a finger) to slide lid part 40 downward to open lid part 40.

As described above, in the present exemplary embodiment, the parts of lid body 41 protruding outward from head housing 300 on the respective opposite sides in the intersecting direction (i.e., the Y-direction) are operation parts 416 that open and close lid part 40 by being hooked with a finger.

Furthermore, one of the parts on which the finger is hooked when lid part 40 is operated in the opening direction (i.e., downward in the Z-direction) has a first amount of protrusion from head housing 300, the first amount being smaller than a second amount of protrusion of the other of the parts on which the finger is hooked when lid part 40 is operated in the closing direction (i.e., upward in the Z-direction) from head housing 300.

Specifically, lid body 41 is formed with thickness D1 of a part (i.e., an upper end of operation part 416) on which the finger is hooked when lid part 40 is operated in the opening direction (i.e., downward in the Z-direction), thickness D1 being thinner than thickness D2 of a part (i.e., a lower end of operation part 416) on which the finger is hooked when lid part 40 is operated in the closing direction (i.e., upward in the Z-direction).

In the present exemplary embodiment, lid body 41 is formed in such a way that thickness D1 thereof is 1.0 mm and thickness D2 thereof is 1.5 mm.

As described above, in the present exemplary embodiment, upper and lower parts of lid body 41 are different in thickness from each other, and thus enables the amounts of upper and lower protrusions to be different from each other only by attaching lid part 40 to head housing 300. This configuration more easily and reliably enables the first amount of protrusion of the part on which the finger is hooked when lid part 40 is operated in the opening direction (i.e., downward in the Z-direction) from head housing 300 to be smaller than the second amount of protrusion of the part on which the finger is hooked when lid part 40 is operated in the closing direction (i.e., upward in the Z-direction) from head housing 300.

Lid part 40 is more reliably prevented from being unintentionally opened by reducing an overlap allowance for the nail (or the finger) when lid part 40 is operated in the opening direction. This configuration more reliably enables preventing hair or liquid accumulated in space S1 from spilling out of opening window S1a.

By the way, when opening window S1a is closed by moving lid part 40 upward in a state where the opening and closing direction of lid part 40 is set to the Z-direction (i.e., the up-down direction of head part 30) while head part 30 is swung in the X-direction (i.e., the front-back direction of head part 30), head part 30 may be likely to be swung in the X-direction when lid part 40 is moved upward.

However, even in such a case, lid part 40 is allowed to be easily operated in the closing direction (i.e., upward in the Z-direction) as long as the second amount of protrusion from head housing 300 at the part on which the finger is hooked when lid part 40 is operated in the closing direction (i.e., upward in the Z-direction) is increased as in the present exemplary embodiment. Thus, swing of head part 30 in the X-direction can be suppressed, so that lid part 40 can be further improved in opening and closing operability.

Operation part 416 is provided with recess 4161, and the opening and closing operation of lid part 40 can be performed using recess 4161 as a mark.

In the present exemplary embodiment the opening and closing operation of opening window S1a is allowed to be performed by sliding lid part 40 in the Z-direction, lid part 40 having an elongated shape in the Y-direction. Thus, lid part 40 includes guide 42 that guides movement of lid body 41 in the opening and closing direction, thereby enabling lid part 40 to be more easily and reliably moved in the opening and closing direction.

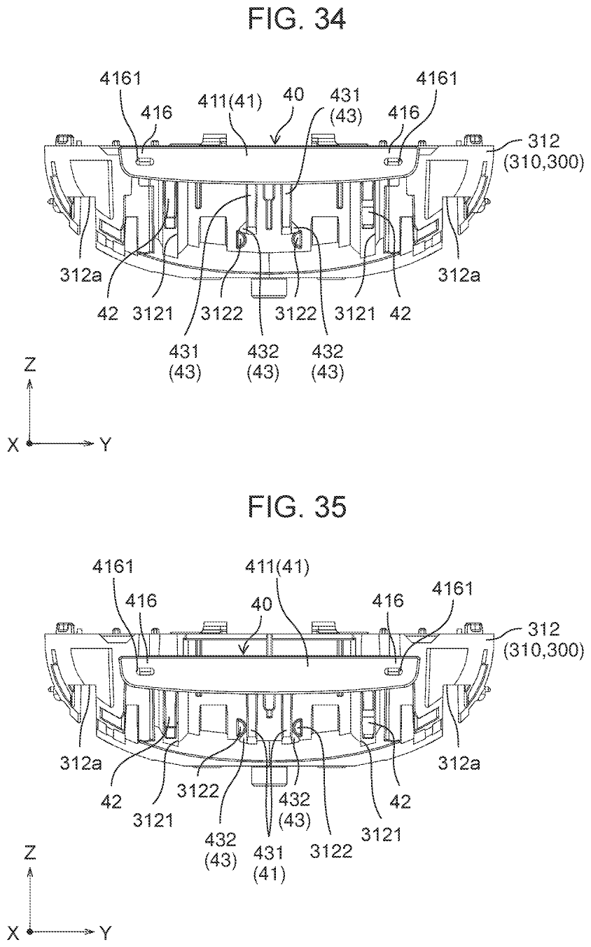

Specifically, as illustrated in FIGS. 34 and 35, paired guides 42 are formed on respective opposite sides of lid body 41 in the Y-direction (i.e., the intersecting direction). Here, FIG. 34 is a diagram illustrating a positional relationship between hook part 43 and a locking part when lid part 40 is closed. FIG. 35 is a diagram illustrating a positional relationship between hook part 43 and the locking part when lid part 40 is opened. Paired guides 42 are each formed to be elongated in the Z-direction, and accommodated in guide groove 3121 formed in inner housing 312 when lid part 40 is attached to head housing 300. When lid part 40 is operated in the opening and closing direction, lid part 40 is moved up and down (i.e., in the Z-direction) while being in sliding contact with inner housing 312. In the present exemplary embodiment, paired guides 42 are formed near respective operation parts 416 formed on the opposite sides of lid body 41 in the Y-direction (i.e., the intersecting direction).

Specifically, at least a part of guide 42 overlaps with operation part 416 in the Z-direction when lid part 40 is viewed in the X-direction. That is, as illustrated in FIGS. 34 and 35, guide 42 is formed in such a way that at least one end of the opposite ends in the Y-direction of guide 42 exists between one end and the other end of operation part 416 in the Y-direction when lid part 40 is viewed in the X-direction.

When lid part 40 is viewed in the Y-direction, at least a part of guide 42 preferably overlaps with operation part 416 in the Z-direction. When lid part 40 is viewed in the Z-direction, at least a part of guide 42 more preferably overlaps with operation part 416.

As described above, guides 42 according to the present exemplary embodiment are provided near respective operation parts 416 formed on the opposite sides of lid body 41 in the Y-direction (i.e., the intersecting direction). When guide 42 as described above is provided, guide 42 suppresses rotation of lid part 40 due to the operation of operation part 416 to move lid part 40 in the opening and closing direction, and thus the opening and closing operation of lid part 40 can be more smoothly performed.

That is, when guides 42 are formed near two respective operation parts 416 formed on the opposite sides of lid body 41 in the intersecting direction (i.e., the Y-direction), opening window S1a can be increased in an opening area while the opening and closing operability of lid part 40 is prevented from being impaired.

In the present exemplary embodiment, lid part 40 includes hook part 43, and when opening window S1a is closed by lid part 40, hook part 43 is releasably locked to locking projection 3122 (i.e., an example of the locking part) formed on head housing 300.

As described above, the present exemplary embodiment allows locking hook part 43 to be releasably locked to locking projection 3122 (i.e., an example of the locking part), thereby maintaining a closed state of lid part 40.

Specifically, as illustrated in FIGS. 34 and 35, paired hook parts 43 are formed on the respective opposite sides of lid part 40 across the center in the Y-direction. Each hook part 43 includes arm part 431 extending downward and locking claw 432 which is provided continuously at a lower end of arm part 431 and protrudes outward in the Y-direction.

On the other hand, inner housing 312 has parts corresponding to respective locking claws 432, the parts being provided with respective paired locking projections 3122 (i.e., an example of the locking part) to which respective hook parts 43 are locked. Each locking projection 3122 (i.e., an example of the locking part) includes curved protruding surface 3123 in a semicircular arcuate shape protruding inward in the Y-direction.

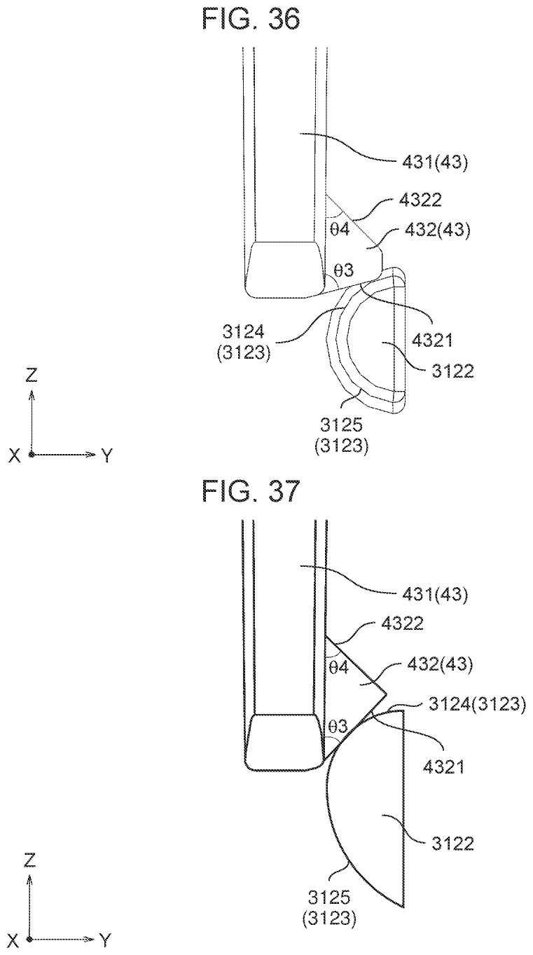

As illustrated in FIG. 36, when lid part 40 is closed, lower inclined surface 4321 (i.e., a first inclined surface) of locking claw 432 is brought into contact with upper surface 3124 (i.e., a surface on one side) of curved protruding surface 3123. Here, FIG. 36 is a diagram illustrating a state in which locking claw 432 of hook part 43 is locked to a locking part when lid part 40 is closed. This configuration prevents lid part 40 from further moving downward in the Z-direction with respect to inner housing 312. As described above, in the present exemplary embodiment, lid part 40 is allowed to be maintained in the closed state by locking lower inclined surface 4321 (i.e., the first inclined surface) of locking claw 432 to upper surface 3124 (i.e., the surface on one side) of curved protruding surface 3123.

When lid part 40 is opened or closed, hook part 43 is about to climb over curved protruding surface 3123.

Specifically, when lid part 40 is moved downward to be shifted from the closed state to the open state, hook part 43 is moved downward while bringing lower inclined surface 4321 (i.e., the first inclined surface) of locking claw 432 into sliding contact with upper surface 3124 (i.e., the surface on one side) of curved protruding surface 3123. At this time, hook part 43 brings lower inclined surface 4321 (i.e., the first inclined surface) into sliding contact with upper surface 3124 (i.e., the surface on one side) while bending arm part 431 inward in the Y-direction. When lower inclined surface 4321 (i.e., the first inclined surface) passes over a top (i.e., a point located innermost in the Y-direction) of curved protruding surface 3123 and climbs over curved protruding surface 3123, hook part 43 is moved downward while moving arm part 431 outward in the Y-direction using elastic restoring force.

Similarly, when lid part 40 is moved upward to be shifted from the open state to the closed state, hook part 43 is moved upward while bringing upper inclined surface 4322 (i.e., a second inclined surface) of locking claw 432 into sliding contact with lower surface 3125 (i.e., a surface on the other side) of curved protruding surface 3123. At this time, hook part 43 brings upper inclined surface 4322 (i.e., the second inclined surface) into sliding contact with lower surface 3125 (i.e., the surface on the other side) while bending arm part 431 inward in the Y-direction. When upper inclined surface 4322 (i.e., the second inclined surface) passes over the top (i.e., the point located innermost in the Y-direction) of curved protruding surface 3123 and climbs over curved protruding surface 3123, hook part 43 moves upward while moving arm part 431 outward in the Y-direction using elastic restoring force. Then, hook part 43 is releasably locked to locking projection 3122 (i.e., an example of the locking part), and the closed state of lid part 40 is maintained.

As described above, in the present exemplary embodiment, head housing 300 is provided with locking projection 3122 (i.e., an example of the locking part) that has curved protruding surface 3123 and can lock lid part 40 in the closed state. Lid part 40 is provided with hook part 43 that can climb over curved protruding surface 3123 when lid part 40 is opened and closed.

Hook part 43 includes lower inclined surface 4321 (i.e., the first inclined surface) that comes into contact with surface 3124 on one side of curved protruding surface 3123 before climbing over curved protruding surface 3123 when lid part 40 is moved from the closed state to the open state, and upper inclined surface 4322 (i.e., the second inclined surface) that comes into contact with surface 3125 on the other side of curved protruding surface 3123 before climbing over curved protruding surface 3123 when lid part 40 is moved from the open state to the closed state.

Since hook part 43 and locking projection 3122 (i.e., an example of the locking part) as described above are provided, the opening and closing operation of lid part 40 can be performed with a click feeling.

Here, in the present exemplary embodiment, inclination angle θ3 of lower inclined surface 4321 (i.e., the first inclined surface) with respect to the opening and closing direction (i.e., in the Z-direction) of lid part 40 is different from inclination angle θ4 of upper inclined surface 4322 (i.e., the second inclined surface) with respect to the opening and closing direction (i.e., in the Z-direction) of lid part 40. This configuration allows lid part 40 to have an operation load in the opening direction that is different from an operating load in the closing direction.

Specifically, inclination angle θ3 of lower inclined surface 4321 (i.e., the first inclined surface) is set larger than inclination angle θ4 of upper inclined surface 4322 (i.e., the second inclined surface).

When inclination angle θ3 of lower inclined surface 4321 (i.e., the first inclined surface) is set larger than inclination angle θ4 of upper inclined surface 4322 (i.e., the second inclined surface) as described above, lid part 40 can be less likely to be moved in the opening direction and can be likely to be moved in the closing direction.

In the present exemplary embodiment, inclination angle θ3 of lower inclined surface 4321 (i.e., the first inclined surface) is set to 75 degrees, and inclination angle θ4 of upper inclined surface 4322 (i.e., the second inclined surface) is set within a range from 20 degrees to 45 degrees.

Lid part 40 is configured to require a pressing force from 400 gf to 600 gf during the opening operation, a pressing from force 200 gf to 400 gf during the closing operation, and an operating force difference of 200 gf between during the opening operation and during the closing operation.

As a result, the pressing force required during the opening operation of lid part 40 causes an operating force for facilitating the opening operation while holding a holding force for preventing lid part 40 from being unintentionally opened due to falling or the like. Then, the pressing force required during the closing operation of lid part 40 causes an operating force as little as possible while maintaining the click feeling.

Causing lid part 40 to be less likely to be moved in the opening direction enables lid part 40 to be more reliably prevented from being unintentionally opened due to contact of lid part 40 with a hand or another object (e.g., a floor surface or the like) during use of electric razor 1 (i.e., an example of a depilatory device) or during cleaning using a cleaning device. The configuration above also enables lid part 40 to be more reliably prevented from being unintentionally opened due to an impact or the like applied at the time of dropping. When lid part 40 can be configured to be more reliably prevented from being unintentionally opened, hair or liquid accumulated in space S1 can be more reliably prevented from spilling out of opening window S1a.

In contrast, causing lid part 40 to be easily moved in the closing direction to improve operability during the closing operation enables head part 30 to be prevented from being swung when lid part 40 is moved in the closing direction, and thus enabling lid part 40 to be further improved in operability when lid part 40 is moved in the closing direction.

When inclination angle θ3 of lower inclined surface 4321 (i.e., the first inclined surface) and inclination angle θ4 of upper inclined surface 4322 (i.e., the second inclined surface) are made different from each other as in the present exemplary embodiment, a simpler configuration enables lid part 40 to have an operation load of in the opening direction that is larger than an operation load in the closing direction.

FIG. 37 is a diagram illustrating a state in which locking claw 432 of hook part 43 is locked to a locking part when lid part 40 is opened using hook part 43 and the locking part according to a modification. As illustrated in FIG. 37, when inclination angle θ3 of lower inclined surface 4321 (i.e., the first inclined surface) and inclination angle θ4 of upper inclined surface 4322 (i.e., the second inclined surface) are set to be equal and curved protruding surface 3123 is formed to have a shape in which surface 3124 on one side has a smaller curvature radius than surface 3125 on the other side, lid part 40 can be less likely to be moved in the opening direction and can be easily moved in the closing direction.

Although FIG. 37 illustrates an example in which inclination angle θ3 of lower inclined surface 4321 (i.e., the first inclined surface) is equal to inclination angle θ4 of upper inclined surface 4322 (i.e., the second inclined surface), inclination angle θ3 of lower inclined surface 4321 (i.e., the first inclined surface) and inclination angle θ4 of upper inclined surface 4322 (i.e., the second inclined surface) may be made different from each other. That is, not only the inclination angles but also the curvature radii can be made different from each other.

This configuration enables lid part 40 to have an operation load in the opening direction that is larger than an operation load in the closing direction with a simpler configuration.

Lid part 40 is not necessarily attached to the position described in the above exemplary embodiment, and can be attached to various positions.

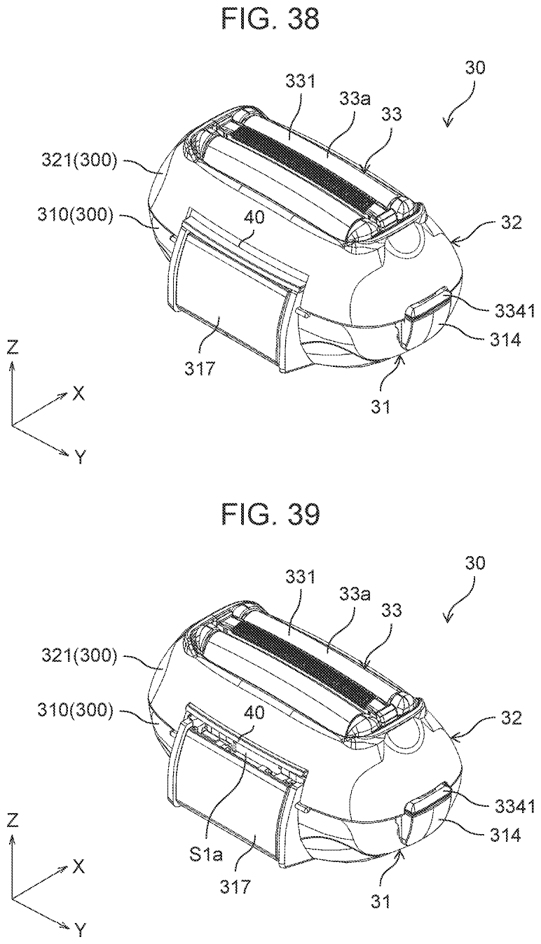

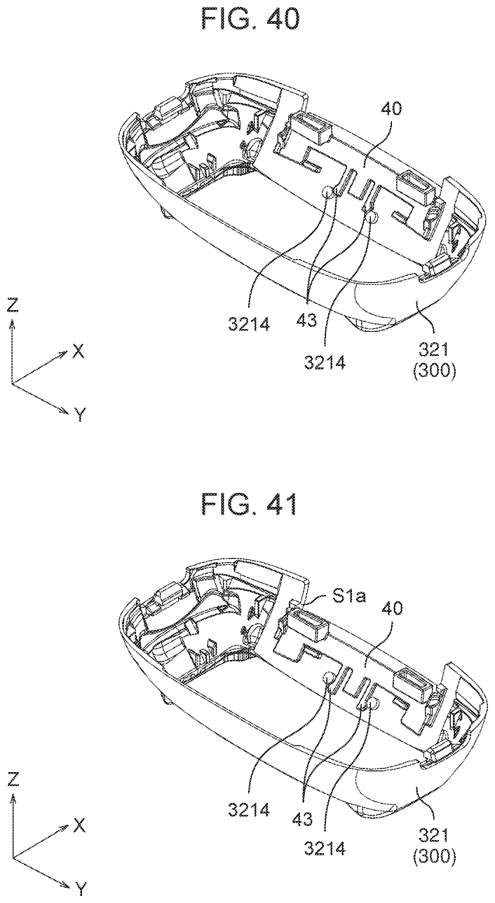

Available examples include a configuration illustrated in FIGS. 38 to 41. FIG. 38 is a perspective view illustrating head part 30 when lid part 40 according to a modification is closed. FIG. 39 is a perspective view illustrating head part 30 when lid part 40 according to the modification is opened. FIG. 40 is a diagram illustrating a positional relationship between hook part 43 and a locking part when lid part 40 according to the modification is closed. FIG. 41 is a diagram illustrating a positional relationship between hook part 43 and the locking part when lid part 40 according to the modification is opened.

Also in the configuration illustrated in FIGS. 38 to 41, head part 30 includes head base part 31 supported by razor body 10 (i.e., the body), and head cover part 32 that is detachably attached to head base part 31 to cover blade part 331 with a part (e.g., the skin contact surface 33a) exposed.

In the configuration of FIGS. 38 to 41, lid part 40 openable and configured to close opening window S1a is attached to cover housing 321 of head cover part 32.

Specifically, opening window S1a is formed above an upper part of trimmer unit 317 in a rear surface of head housing 300, and lid part 40 is attached to cover housing 321 so as to open and close opening window S1a. Lid part 40 only needs to be attached to cover housing 321, and thus can be attached to any place on peripheral wall part 3213.

Also in the configuration illustrated in FIGS. 38 to 41, opening window S1a is opened and closed by sliding lid part 40 along the surface of head housing 300 (i.e., the surface with opening window S1a). In the configuration illustrated in FIGS. 38 to 41, lid part 40 is slid in the up-down direction to open or close opening window S1a. When lid part 40 is slid downward, opening window S1a is closed by lid part 40.

Also in the configuration illustrated in FIGS. 38 to 41, the opening and closing direction (i.e., in the Z-direction) of lid part 40 intersects trajectory B1 drawn by lid part 40 when head part 30 is relatively reciprocated with respect to razor body 10 (i.e., the body) in the first direction (i.e., the X-direction).

Lid part 40 also includes hook part 43, and when opening window S1a is closed by lid part 40, hook part 43 is releasably locked to locking projection 3214 (i.e., an example of the locking part) formed on head housing 300.

As described above, when lid part 40 is attached to head cover part 32 and rotation center C1 exists on an upper side of head part 30, lid part 40 is allowed to be brought close to rotation center C1, so that lid part 40 can be further improved in opening and closing operability. Head part 30 also can be further improved in design while head part 30 is reduced in size. Additionally, opening window S1a is provided near blade part 331, so that blade part 331 can be cleaned more efficiently.

Lid part 40 is also provided near blade part 331, so that blade part 331 can be more reliably cleaned.

[Actions and Effects]

Hereinafter, a characteristic configuration of electric razor (e.g., an example of depilatory device) described in the exemplary embodiment and the modification of the exemplary embodiment, and an effect obtained by the characteristic configuration will be described.

Electric razor 1 (i.e., an example of depilatory device) described in the exemplary embodiment and the modification of the exemplary embodiment includes razor body 10 (i.e., the body), and head part 30 that includes blade part 331 capable of cutting hair and is supported by razor body 10 (i.e., the body) while being capable of relatively reciprocating with respect to razor body 10 (i.e., the body) in the first direction (i.e., the X-direction). Head part 30 includes head housing 300 provided inside with space S1, and head housing 300 is provided with opening window S1a communicating with space S1. Lid part 40 that is openable and configured to cover opening window S1a is also attached to head housing 300. The opening and closing direction (i.e., in the Z-direction) of lid part 40 intersects trajectory B1 drawn by lid part 40 when head part 30 is relatively reciprocated with respect to razor body 10 (i.e., the body) in the first direction (i.e., the X-direction).

As described above, when head part 30 is supported by razor body 10 (i.e., the body) while being movable relative to razor body 10 (i.e., the body) in the first direction (i.e., the X-direction), blade part 331 can be brought into closer contact with the skin when electric razor 1 (i.e., an example of the depilatory device) is in use. As a result, beard (i.e., an example of hair) can be more efficiently removed (more specifically, shaved).

When opening window S1a communicating with space S1 is provided in head housing 300 and opening window S1a is covered with lid part 40 that is operable and attached to head housing 300, liquid such as water can be introduced into space S1 through opening window S1a or hair, or liquid accumulated in space S1 can be discharged through opening window S1a only by operating lid part 40. As a result, the inside of space S1 can be cleaned more easily and the liquid can be introduced into space S1 more easily.

When the opening and closing direction (i.e., in the Z-direction) of lid part 40 is set to be a direction intersecting trajectory B1 drawn by lid part 40 when head part 30 is relatively reciprocated with respect to razor body 10 (i.e., the body) in the first direction (i.e., the X-direction), lid part 40 can be opened and closed by applying a force in the direction intersecting trajectory B1 to lid part 40. As described above, when a force in the direction intersecting trajectory B1 is applied to lid part 40 to open or close lid part 40, a component force in a direction along trajectory B1 can be reduced as much as possible, and thus enabling head part 30 to be further prevented from moving relative to razor body 10 (i.e., body) in the first direction (i.e., the X-direction) when lid part 40 is opened or closed. As a result, lid part 40 can be further improved in opening and closing operability.

As described above, when electric razor 1 (i.e., an example of the depilatory device) described in each of the exemplary embodiment and the modification of the exemplary embodiment is used, head part 30 is moved relative to razor body 10 (body) to allow lid part 40 to be further improved in opening and closing operability while adherence of blade part 331 to the skin is further improved.

The first direction (i.e., the X-direction) may be the front-back direction of head part 30.

This configuration enables even electric razor 1 (i.e., an example of the depilatory device) capable of moving head part 30 relative to razor body 10 (i.e., the body) in the front-rear direction to further improve the opening and closing operability of lid part 40.

Head part 30 may be supported by razor body 10 (i.e., the main body) while being movable relative to razor body 10 (i.e., the body) in a direction (i.e., the Y-direction and the Z-direction) intersecting the first direction (i.e., the X-direction).

This configuration enables even electric razor 1 (i.e., an example of the depilatory device) capable of moving head part 30 relative to razor body 10 (i.e., the body) in multiple directions to further improve the opening and closing operability of lid part 40. Thus, electric razor 1 (i.e., an example of the depilatory device) can be obtained in which lid part 40 can be further improved in opening and closing operability while blade part 331 is further improved in adhesion to the skin.

Head part 30 may be supported by razor body 10 (i.e., the body) so as to be swung in the first direction (i.e., the X-direction). Distance L1 from rotation center C1 of head part 30 to lid part 40 may be shorter than longest distance L2 from rotation center C1 of head part 30.

This configuration enables lid part 40 to be brought closer to rotation center C1 of head part 30. Thus, when a force is applied to lid part 40 to open and close lid part 40, a component force in a direction along trajectory B1 is generated at a position close to rotation center C1 of head part 30. Thus, unless a relatively large force is applied to lid part 40 when lid part 40 is opened and closed, head part 30 can be prevented from being swung. That is, to swing head part 30 using a force applied to lid part 40 when lid part 40 is opened or closed, a relatively large force can be required to be applied to lid part 40. As a result, head part 30 is prevented from being swung when lid part 40 is opened or closed, so that lid part 40 can be further improved in opening and closing operability.

Head part 30 may be supported by razor body 10 (the body) using coupling mechanism 20. Coupling mechanism 20 may include link mechanism 28 that swings head part 30 in the first direction (i.e., the X-direction) about virtual axis μl extending in the second direction (i.e., the Y-direction) intersecting the first direction (i.e., the X-direction) with respect to razor body 10 (i.e., the body). Link mechanism 28 may further include connection end part 2823 that is connected to head part 30. When head part 30 is viewed in the second direction (i.e., the Y-direction), lid part 40 may exist inside virtual circle C2 about virtual axis μl, virtual circle C2 passing through connection end part 2823.

This configuration enables lid part 40 to be located at a position close to virtual axis μl serving as rotation center C1 of head part 30, so that a component force in a direction along trajectory B1 is generated at a position close to rotation center C1 of head part 30 when a force is applied to lid part 40 to open and close lid part 40. Thus, unless a relatively large force is applied to lid part 40 when lid part 40 is opened and closed, head part 30 can be prevented from being swung. That is, to swing head part 30 using a force applied to lid part 40 when lid part 40 is opened or closed, a relatively large force can be required to be applied to lid part 40. As a result, head part 30 is prevented from being swung when lid part 40 is opened or closed, so that lid part 40 can be further improved in opening and closing operability.

When head part 30 is viewed in the second direction (i.e., the Y-direction), virtual axis μl may be located outside head part 30.

This configuration enables the whole of head part 30 to be moved toward the same side (i.e., the front side or the rear side) in the first direction (i.e., the X-direction) when head part 30 is swung in the first direction (i.e., the X-direction). That is, trajectory B1 changed in direction depending on a place where lid part 40 is attached to head part 30 as in when virtual axis μl exists inside head part 30 is prevented.

Thus, lid part 40 can be further improved in degree of freedom of its attachment position to head part 30 and degree of freedom of its opening and closing direction. For example, when lid part 40 is opened or closed by being moved along a surface of head part 30, the opening and closing direction of lid part 40 can be set to intersect trajectory B1 even when lid part 40 is moved in various directions. When lid part 40 is moved along the surface of head part 30 to be opened or closed, electric razor 1 (i.e., an example of the depilatory device) can be reduced in size with a simple configuration.

Head housing 300 may be provided with opening window S1a that opens in the first direction (i.e., the X-direction).

When lid part 40 is opened or closed by being moved along the surface of head part 30, the configuration above enables the opening and closing direction of lid part 40 to be set to intersect trajectory B1 even when lid part 40 is moved in in any direction. Thus, the opening and closing direction of lid part 40 can be intersected with trajectory B1 more easily and reliably.

Lid part 40 may have an operation load in the opening direction that is different from an operation load in the closing direction.

This configuration enables lid part 40 to be less likely to be moved in the opening direction or in the closing direction. At this time, causing lid part 40 to be less likely to be moved in the opening direction enables lid part 40 to be more reliably prevented from being unintentional opened due to contact of lid part 40 with a hand or another object (e.g., a floor surface or the like) during use of electric razor 1 (i.e., an example of a depilatory device) or during cleaning using a cleaning device. The configuration above also enables lid part 40 to be more reliably prevented from being unintentionally opened due to an impact or the like applied at the time of dropping. As described above, when lid part 40 can be configured to be more reliably prevented from being unintentionally opened, hair or liquid accumulated in space S1 can be more reliably prevented from spilling out of opening window S1a. Additionally, lid part 40 is improved in operability when being moved in the closing direction (more specifically, lid part 40 can be easily moved in the closing direction), so that head part 30 can be prevented from being swung when lid part 40 is moved in the closing direction.

In contrast, causing lid part 40 to be less likely to be moved in the closing direction enables lid part 40 to be more reliably prevented from being unintentionally closed when the inside of space S1 is washed while water with lid part 40 is opened, for example.

Lid part 40 may have an operation load in the opening direction that is larger than an operation load in the closing direction.

This configuration enables lid part 40 to be less likely to be moved in the opening direction, so that lid part 40 not only can be more reliably prevented from being unintentionally opened, but also can be further improved in operability when being moved in the closing direction.

At least one of head housing 300 and lid part 40 may include a member provided with locking projection 3122 (i.e., an example of the locking part) having curved protruding surface 3123 and capable of locking lid part 40 in a closed state, and at least the other of head housing 300 and lid part 40 may include a member provided with hook part 43 capable of climbing over curved protruding surface 3123 when lid part 40 is opened or closed. Furthermore, hook part 43 may further include lower inclined surface 4321 (i.e., the first inclined surface) that comes into contact with curved protruding surface 3123 before climbing over curved protruding surface 3123 when lid part 40 is moved from the closed state to the open state, and upper inclined surface 4322 (i.e., the second inclined surface) that comes into contact with curved protruding surface 3123 before climbing over curved protruding surface 3123 when lid part 40 is moved from the open state to the closed state. Inclination angle θ3 of lower inclined surface 4321 (i.e., the first inclined surface) with respect to the opening and closing direction (i.e., in the Z-direction) of lid part 40 may be larger than inclination angle θ4 of upper inclined surface 4322 (i.e., the second inclined surface) with respect to the opening and closing direction (i.e., in the Z-direction) of lid part 40.

This configuration enables lid part 40 to have an operation load in the opening direction that is larger than an operation load in the closing direction with a simpler configuration. As a result, lid part 40 can be less likely to be moved in the opening direction.

At least one of head housing 300 and lid part 40 may include a member provided with locking projection 3122 (i.e., an example of the locking part) having curved protruding surface 3123 and capable of locking lid part 40 in a closed state, and at least the other of head housing 300 and lid part 40 may include a member provided with hook part 43 capable of climbing over curved protruding surface 3123 when lid part 40 is opened or closed. Furthermore, hook part 43 may further include lower inclined surface 4321 (i.e., the first inclined surface) that comes into contact with surface 3124 on one side of curved protruding surface 3123 before climbing over curved protruding surface 3123 when lid part is moved from the closed state to the open state, and upper inclined surface 4322 (i.e., the second inclined surface) that comes into contact with surface 3125 on the other side of curved protruding surface 3123 before climbing over curved protruding surface 3123 when lid part 40 is moved from the open state to the closed state. Curved protruding surface 3123 may include surface 3124 on one side that has a smaller curvature radius than surface 3125 on the other side.

This configuration also enables lid part 40 to have an operation load in the opening direction that is larger than an operation load in the closing direction with a simpler configuration. As a result, lid part 40 can be less likely to be moved in the opening direction.

Lid part 40 may include lid body 41 that is openable and configured to cover opening window S1a, and guide 42 that guides movement of lid body 41 in the opening and closing direction.

This configuration enables lid part 40 to be more easily and reliably moved in the opening and closing direction.

Lid body 41 has an elongated shape in an intersecting direction (i.e., the Y-direction) intersecting the opening and closing direction (i.e., the Z-direction) of lid part and may be provided on opposite sides in the intersecting direction (i.e., the Y-direction) with respective operation parts 416 for opening and closing lid part 40 in the crossing direction. Guide 42 may be formed near each of operation parts 416.

This configuration enables opening window S1a to be increased in opening area not only to introduce liquid such as water into space S1 through opening window S1a more efficiently, but also to discharge hair or liquid accumulated in space S1 through opening window S1a more efficiently. Furthermore, when operation part 416 is operated to move lid part 40 in the opening and closing direction, lid part 40 is prevented from rotating, and thus the opening and closing operation of lid part 40 can be performed more smoothly. As described above, when guides 42 are formed near two respective operation parts 416 formed on the opposite sides of lid body 41 in the intersecting direction (i.e., the Y-direction), opening window S1a can be increased in an opening area while the opening and closing operability of lid part 40 is prevented from being impaired.

Lid part 40 may be attached to head housing 300 in a state where at least a part of lid body 41 protrudes outward from head housing 300. Parts of lid body 41 protruding outward from head housing 300 on the respective opposite sides in the intersecting direction (i.e., the Y-direction) may serve as operation parts 416 that open and close lid part 40 by being hooked with a finger. Furthermore, one of the parts on which the finger is hooked when lid part 40 is operated in the opening direction (i.e., downward in the Z-direction) has the first amount of protrusion from head housing 300 that may be smaller than the second amount of protrusion of the other of the parts on which the finger is hooked when lid part 40 is operated in the closing direction (i.e., upward in the Z-direction) from head housing 300.

This configuration enables lid part 40 to be more reliably prevented from being unintentionally opened, so that hair or liquid accumulated in space S1 can be more reliably prevented from spilling out of opening window S1a.

This configuration also enables lid body 41 exposed to the outside to be simplified is shape, so that head part 30 can be further improved in design.

When opening window S1a is closed by moving lid part 40 upward in a state where the opening and closing direction of lid part 40 is set to the Z-direction (i.e., the up-down direction of head part 30) while head part 30 is swung in the X-direction (i.e., the front-back direction of head part 30), head part 30 may be likely to be swung in the X-direction when lid part 40 is moved upward.

However, even such a case, lid part 40 is allowed to be easily operated in the closing direction (i.e., upward in the Z-direction) as long as the second amount of protrusion from head housing 300 at the part on which the finger is hooked when lid part 40 is operated in the closing direction (i.e., upward in the Z-direction) is increased. Thus, swing of head part 30 in the X-direction can be suppressed, so that lid part 40 can be further improved in opening and closing operability.

Head part 30 may also include head base part 31 supported by razor body 10 (i.e., the body), and head cover part 32 that is detachably attached to head base part 31 to cover blade part 331 in a state where a part (e.g., the skin contact surface 33a) is exposed. Lid part 40 may be attached to head cover part 32.

This configuration enables lid part 40 to be brought close to rotation center C1 when rotation center C1 exists on an upper side of head part 30, so that lid part 40 can be further improved in opening and closing operability. Head part 30 also can be further improved in design while head part 30 is reduced in size. Additionally, opening window S1a is provided near blade part 331, so that blade part 331 can be cleaned more efficiently.

[Others]

Although the contents of the depilatory device according to the present disclosure have been described above, the present disclosure is not limited to these descriptions, and it is obvious to those skilled in the art that various modifications and improvements can be made.

For example, the present disclosure can be applied to exemplary embodiments in which changes, replacements, additions, omissions, and the like of the configurations described in the exemplary embodiment and the modification examples thereof are made. Additionally, a new exemplary embodiment can be made by combining each component described in the exemplary embodiment and the modification thereof.

In the exemplary embodiment and the modification thereof, exemplified is blade unit 33 including three blade blocks. However, blade unit 33 may include two blade blocks, or four or more blade blocks.

In the exemplary embodiment and the modification thereof, exemplified is one lid part 40 attached to head housing 300. However, multiple lid parts 40 may be attached to head housing 300. In this case, two or more lid parts 40 are allowed to be moved in conjunction with each other during the opening and closing operation, and each of two or more lid parts 40 are allowed to be moved separately and independently.

In the exemplary embodiment and the modification thereof, exemplified is lid part 40 that exists inside virtual circle C2 when head part 30 is viewed in the second direction (i.e., the Y-direction). However, lid part 40 may exist outside virtual circle C2.

In the exemplary embodiment and the modification thereof, exemplified is virtual axis μl located outside head part 30 when head part 30 is viewed in the second direction (i.e., the Y-direction). However, head part 30 may be swung with respect to razor body 10 (i.e., the body) about virtual axis μl existing inside head part 30.

In the exemplary embodiment and the modification thereof, exemplified is opening window S1a opened in the first direction (i.e., the X-direction). However, opening window S1a may be opened in a direction intersecting the first direction (i.e., the X-direction). For example, opening window S1a may be formed at an end of head housing 300 (i.e., a side wall of head housing 300) in the width direction (i.e., the Y-direction) while head part 30 is swung in the first direction (i.e., the X-direction) with respect to razor body 10 (the body).

In the exemplary embodiment and the modification thereof, exemplified is lid part 40 that is moved along the surface of head part 30. However, lid part 40 may be moved in a direction intersecting the surface of head part 30. For example, as in the electric razor (i.e., an example of the depilatory device) disclosed in PTL 1, the lid part may have an opening and closing direction set to the front-rear direction when the lid part is provided on the front surface of the head part while the head part can be swung about a central part of the head part as an axis in the width direction with respect to the body.

In the exemplary embodiment and the modification thereof, exemplified is the structure in which the part on which the finger is hooked when lid part 40 is operated in the opening direction has thickness D1 that is thinner than thickness D2 of the part on which the finger is hooked when lid part 40 is operated in the closing direction, thereby setting the first amount of protrusion of the part on which the finger is hooked when lid part 40 is operated in the opening direction to be smaller than the second amount of protrusion of the part on which the finger is hooked when lid part 40 is operated in the closing direction. However, the first amount of protrusion of the part on which the finger is hooked when lid part 40 is operated in the opening direction may be set to be smaller than the second amount of protrusion of the part on which the finger is hooked when lid part 40 is operated in the closing direction while thickness D1 and thickness D2 are set to be equal to each other.

In the exemplary embodiment and the modification thereof, exemplified is lid part provided with hook part 43, and head housing 300 provided with locking projection 3122 (i.e., an example of the locking part). However, lid part 40 may be provided with a locking part and head housing 300 may be provided with a hook part. Lid part 40 may be provided with a hook part and a locking part and head housing 300 may be provided with a locking part and hook part to lock the hook part of lid part 40 and the locking part of head housing 300. In this way, the locking part of lid part 40 and the hook part of head housing 300 are locked with each other.

In the exemplary embodiment and the modification thereof, exemplified is the first direction that is the X-direction (i.e., the front-back direction of head part 30). However, the first direction may be the Y-direction (i.e., the width direction of head part 30). The first direction may be the Z-direction (i.e., the up-down direction of head part 30).

In the exemplary embodiment and the modification thereof, exemplified is electric razor 1 in which the inner blade reciprocates linearly with respect to the outer blade. However, the present disclosure is also applicable to an electric razor of a rotary blade type in which an inner blade rotates with respect to an outer blade.

In the exemplary embodiment and the modification thereof, exemplified is the structure in which lid part 40 is provided in opening window S1a communicating with space S1 where cut beard can be stored, and lid part 40 is opened to allow water or washing liquid to be introduced into opening window S1a and the water or the cleaning solution to be discharged from opening window S1a. However, the present disclosure is also applicable to a depilatory device having a space for storing lotion, cream, or the like for skin care.

In the exemplary embodiment and the modification thereof, exemplified is electric razor 1 that cuts beard as the depilatory device. However, the present disclosure is applicable not only to electric razor 1 but also to various types of depilatory device. For example, the present disclosure is applicable to a trimer that cuts body hair and hair of a human or an animal (e.g., an electric hair cutting device).

In addition, specifications, such as shape, size, and layout, of the head part, the lid part, and other details can be changed as appropriate.

As described above, the depilatory device according to the present disclosure enables the lid part to be further improved in opening and closing operability while moving the head part relative to the body, and thus is applicable to treatment and the like of not only beard but also various types of body hair.

What is claimed is:

1. A depilatory device comprising:
a body; and
a head part,
wherein
the head part comprises a blade part which is configured to cut hair and supported by the body in a state where the head part is reciprocatable relative to the body in a first direction; and
the head part comprises a head housing provided inside with a space,
the head housing comprises an opening window communicating with the space,
the opening window is covered with a lid part that is openable and attached to the head housing, and
the lid part has an opening and closing direction intersecting a trajectory drawn by the lid part when the head part is reciprocated relative to the body in the first direction.

2. The depilatory device according to claim 1, wherein
the first direction is a front-back direction of the head part.

3. The depilatory device according to claim 1, wherein
the head part is supported by the body in a state of being movable relative to the body in a direction intersecting the first direction.

4. The depilatory device according to claim 1, wherein
the head part is supported by the body in such a way that the head part is swung in the first direction, and
the head part has a rotation center with a distance from the lid part, the distance being shorter than a longest distance from the rotation center of the head part.

5. The depilatory device according to claim 1, wherein
the head part is supported by the body using a coupling mechanism,
the coupling mechanism comprises a link mechanism that causes the head part to be swung in the first direction about a virtual axis with respect to the body, the virtual axis extending in a second direction intersecting the first direction,
the link mechanism comprises a connection end connected to the head part, and
the lid part exists inside a virtual circle about the virtual axis, the virtual circle passing through the connection end when the head part is viewed in the second direction.

6. The depilatory device according to claim 5, wherein
the virtual axis is located outside the head part when the head part is viewed in the second direction.

7. The depilatory device according to claim 6, wherein
the opening window is formed in the head housing so as to open in the first direction.

8. The depilatory device according to claim 1, wherein
the lid part has a first operation load in an opening direction of the lid part, the first operation load being different from a second operation load in a closing direction of the lid part.

9. The depilatory device according to claim 8, wherein
the first operation load in the opening direction of the lid part is larger than the second operation load in the closing direction of the lid part.

10. The depilatory device according to claim 9, wherein
at least one selected from the group consisting of the head housing and the lid part includes a first member provided with a locking part having a curved protruding surface and capable of locking the lid part in a closed state,
at least another selected from the group consisting of the head housing and the lid part includes a second member provided with a hook part capable of climbing over the curved protruding surface when the lid part is opened or closed,
the hook part includes a first inclined surface that comes into contact with the curved protruding surface before climbing over the curved protruding surface when the lid part is moved from the closed state to the open state, and a second inclined surface that comes into contact with the curved protruding surface before climbing over the curved protruding surface when the lid part is moved from the open state to the closed state, and
the first inclined surface has a first inclination angle with respect to the opening and closing direction of the lid part, the first inclination angle being larger than a second inclination angle of the second inclined surface with respect to the opening and closing direction of the lid part.

11. The depilatory device according to claim 9, wherein
at least one selected from the group consisting of the head housing and the lid part includes a first member provided with a locking part having a curved protruding surface and capable of locking the lid part in a closed state,
at least another selected from the group consisting of the head housing and the lid part includes a second member provided with a hook part capable of climbing over the curved protruding surface when the lid part is opened or closed,
the hook part includes a first inclined surface that comes into contact with a first surface on one side of the curved protruding surface before climbing over the curved protruding surface when the lid part is moved from the closed state to the open state, and a second inclined surface that comes into contact with a second surface on another side of the curved protruding surface before climbing over the curved protruding surface when the lid part is moved from the open state to the closed state, and
the curved protruding surface includes the first surface on the one side that has a smaller curvature radius than the second surface on the other side.

12. The depilatory device according to claim 1, wherein
the lid part comprises a lid body that is openable and configured to cover the opening window, and a guide that guides movement of the lid body in the opening and closing direction.

13. The depilatory device according to claim 12, wherein
the lid body has an elongated shape in an intersecting direction intersecting the opening and closing direction of the lid part,
the lid body is provided on opposite sides in the intersecting direction with respective operation parts configured to open and close the lid part, and
the guide is formed near each of the operation parts.

14. The depilatory device according to claim 13, wherein
the lid part is attached to the head housing in a state where at least a part of the lid body protrudes outward from the head housing,
the lid body includes parts protruding outward from the head housing on the respective opposite sides of the lid body in the intersecting direction, the parts each serving as the operation part that opens or closes the lid part by being hooked with a finger, and
one of the parts on which the finger is hooked when the lid part is operated in the opening direction has a first amount of protrusion from the head housing, the first amount is smaller than a second amount of protrusion of another of the parts on which the finger is hooked when the lid part is operated in the closing direction from the head housing.

15. The depilatory device according to claim 1, wherein
the head part includes a head base part supported by the body, and a head cover part that is detachably attached to the head base part to cover the blade part in a state where a part is exposed, and
the lid part is attached to the head cover part.
